(19) United States
(12) Patent Application Publication
(10) Pub. No.: US 2023/0362718 A1
(43) Pub. Date: Nov. 9, 2023

(54) COMMUNICATION DEVICE AND COMMUNICATION METHOD

(71) Applicant: Sony Group Corporation, Tokyo (JP)

(72) Inventor: Shigeru SUGAYA, Tokyo (JP)

(73) Assignee: Sony Group Corporation, Tokyo (JP)

(21) Appl. No.: 18/004,884

(22) PCT Filed: Jul. 2, 2021
(86) PCT No.: PCT/JP2021/025087

§ 371 Date: Jan. 10, 2023

(30) Foreign Application Priority Data
Jul. 17, 2020 (JP) 2020-123091

(51) Int. Cl. H04W 28/04; H04W 28/10; H04W 72/12

(52) U.S. Cl. CPC H04W 28/04; H04W 28/10; H04W 72/12

(57) ABSTRACT

The present technology relates to a communication device and a communication method capable of reliably performing data communication with a shorter delay time.

There is provided a communication device including a control unit that performs control to construct control information including information regarding a reception capacity of data to be received at a predetermined transmission cycle, transmit the constructed control information in a case where a transmission opportunity is acquired by random access control with another communication device, and receive data corresponding to a reception capacity based on the control information, the data being transmitted from the another communication device. The present technology can be applied to, for example, devices constituting a wireless LAN system.

### TECHNICAL FIELD

The present technology relates to a communication device and a communication method, and more particularly to a communication device and a communication method capable of reliably performing data communication with a shorter delay time.

### BACKGROUND ART

In a wireless local area network (LAN) system, a network is constructed and operated among a plurality of communication devices, and thus an access control method has been employed in which any communication device can transmit data after a predetermined random transmission waiting time elapses.

As a technique related to this type of access control method, for example, a technique disclosed in Patent Document 1 is known.

Patent Document 1 discloses a wireless communication device that transmits a polling signal for requesting transmission of data to a communication partner device when data is received in a case where one of devices determines to acquire an access right on the basis of communication quality or identification information and the own device acquires the access right of a shared frequency band, and waits until the data or the polling signal is received from the communication partner device in a case where the communication partner device acquires the access right.

### CITATION LIST

### Patent Document

Patent Document 1: Japanese Patent Application Laid-Open No. 2016-046648

### SUMMARY OF THE INVENTION

### Problems to be Solved by the Invention

Meanwhile, in an environment where a random access control delay occurs such as a wireless LAN system, it is required to reliably transmit data by suppressing the influence of the delay.

The present technology has been made in view of such a situation, and is intended to enable data communication to be reliably performed with a shorter delay time.

### Solutions to Problems

A communication device according to one aspect of the present technology is a communication device including a control unit that performs control to construct control information including information regarding a reception capacity of data to be received at a predetermined transmission cycle, transmit the constructed control information in a case where a transmission opportunity is acquired by random access control with another communication device, and receive data corresponding to a reception capacity based on the control information, the data being transmitted from the another communication device.

A communication method according to one aspect of the present technology is a communication method including, by a communication device, constructing control information including information regarding a reception capacity of data to be received at a predetermined transmission cycle, transmitting the constructed control information in a case where a transmission opportunity is acquired by random access control with another communication device, and receiving data corresponding to a reception capacity based on the control information, the data being transmitted from the another communication device.

In the communication device and the communication method according to one aspect of the present technology, control information including information regarding a reception capacity of data to be received at a predetermined transmission cycle is constructed, the constructed control information is transmitted in a case where a transmission opportunity is acquired by random access control with another communication device, and data corresponding to a reception capacity based on the control information is received, the data being transmitted from the another communication device.

A communication device according to one aspect of the present technology is a communication device including a control unit that performs control to receive predetermined control information constructed according to a predetermined transmission cycle and transmitted from another communication device, construct data to be transmitted on the basis of information regarding a reception capacity of data included in the received control information, and transmit the constructed data in a case where a transmission opportunity is acquired by random access control with the another communication device.

A communication method according to one aspect of the present technology is a communication method including, by a communication device, receiving predetermined control information constructed according to a predetermined transmission cycle and transmitted from another communication device, constructing data to be transmitted on the basis of information regarding a reception capacity of data included in the received control information, and transmitting the constructed data in a case where a transmission opportunity is acquired by random access control with the another communication device.

In the communication device and the communication method according to one aspect of the present technology, predetermined control information constructed according to a predetermined transmission cycle and transmitted from another communication device is received, data to be transmitted is constructed on the basis of information regarding a reception capacity of data included in the received control information, and the constructed data is transmitted in a case where a transmission opportunity is acquired by random access control with the another communication device.

Note that the communication device of one aspect of the present technology may be an independent device or an internal block constituting one device.

### BRIEF DESCRIPTION OF DRAWINGS

FIG. 1 is a diagram illustrating an example of a configuration of a wireless communication network by a wireless communication system to which the present technology is applied.

FIG. 2 is a diagram illustrating a flow of processing of specifying an amount of data of a real time application.

FIG. 3 is a diagram illustrating a flow of processing of estimating a reception capacity.

FIG. 4 is a diagram illustrating an example of setting a transmission parameter.

FIG. 5 is a block diagram illustrating an example of a configuration of a communication device to which the present technology is applied.

FIG. 6 is a block diagram illustrating an example of a configuration of a wireless communication module of FIG. 5.

FIG. 7 is a diagram illustrating an example of data transmission by a communicable signal from a reception side communication device.

FIG. 8 is a diagram illustrating another example of data transmission by the communicable signal from the reception side communication device.

FIG. 9 is a diagram illustrating an example of data transmission including retransmission data by the communicable signal indicating a reception status.

FIG. 10 is a diagram illustrating another example of data transmission including retransmission data by the communicable signal indicating the reception status.

FIG. 11 is a diagram illustrating an example of a configuration of a frame format.

FIG. 12 is a diagram illustrating a configuration of control information configured as the communicable signal.

FIG. 13 is a diagram illustrating an example of a configuration of a command related to setup of the real time application.

FIG. 14 is a diagram illustrating an example of a configuration of frame aggregation configured by aggregating a plurality of data.

FIG. 15 is a diagram illustrating an example of a sequence of parameter exchange of the real time application.

FIG. 16 is a diagram illustrating an example of a sequence of terminating communication of the real time application.

FIG. 17 is a diagram illustrating an example of a communication sequence of the real time application.

FIG. 18 is a diagram illustrating another example of the communication sequence of the real time application.

FIG. 19 is a flowchart describing a communication setup operation.

FIG. 20 is a flowchart describing the communication setup operation.

FIG. 21 is a flowchart describing operation of the reception side communication device.

FIG. 22 is a flowchart describing the operation of the reception side communication device.

FIG. 23 is a flowchart describing operation of a transmission side communication device.

FIG. 24 is a flowchart describing the operation of the transmission side communication device.

### MODE FOR CARRYING OUT THE INVENTION

<1. Embodiments of present technology>

Conventionally, in a wireless LAN system, a network is constructed and operated among a plurality of communication devices, and thus an access control method has been uniformly employed in which all communication devices can transmit data after a predetermined random transmission waiting time elapses.

In recent years, applications that distribute video information in real time are used more and more, and there is an increasing need to transmit video information of content desired by a user as a real time application.

In order to apply to such an application, a method of reducing a delay by transmitting data without omission in a case where a transmission opportunity (access right) is acquired has been considered.

However, these real time applications have a configuration in which video information desired by the user is set in a system such as a live broadcast channel, and the video information is transmitted from the distributor in a framework of the system.

In a case of distributing such video information, a technique and a method have been devised in which a broadband channel is secured in advance so that congestion does not occur in wireless transmission on a communication channel, and data is transmitted without requiring a transmission waiting time by using an arbitrary frequency channel.

In these wireless communications, a system is employed in which frequency resources are allocated from a base station to a communication terminal and used, and thus it is easy to provide a mechanism for transmitting data from a specific communication device without delay if the frequency resource is allocated.

Furthermore, in the wireless LAN system, as a conventional technique, there has been considered a method capable of notifying not only surroundings of a transmission side communication device but also surroundings of a reception side communication device that the transmission path is being used by request to send/clear to send (RTS/CTS) control prior to data transmission.

Moreover, in the wireless LAN system, after data transmission, it is necessary to confirm whether data has been correctly received by returning an acknowledgment (ACK) from the reception side communication device, and in a case where this ACK is not returned, it is necessary to retransmit all data.

Meanwhile, in a case of the wireless LAN system, when there are many communication devices waiting for transmission in the surroundings of the own device, there is a case where, even after a random transmission waiting time has elapsed, the own device cannot perform its own transmission if transmission from another communication device is performed.

In particular, in recent years, with the explosive spread of wireless LAN systems, when many networks constructed by other access points exist adjacent to each other in the surroundings of the network constructed by the access point to which the own device belongs, there has been a possibility to use the same channel as those of the other communication devices.

In a case where data of a real time application is transmitted, when the transmission side communication device acquires a transmission opportunity and then collectively transmits data equal to or more than a buffer capacity for storing data received by the reception side communication device, there is a possibility that, despite that data communication itself is completed, data that cannot be stored in the buffer cannot be delivered to the application.

In a wireless LAN system, since such fair access control is performed, there is a problem that it is difficult to transmit data of the real time application within a predetermined delay time, and moreover, even if data is transmitted after the random transmission waiting time, an influence on other communication cannot be eliminated, and thus it is necessary to exchange an acknowledgment (ACK) to determine success or failure after the data transmission.

Moreover, in the wireless LAN system, in order to cause data transmission from other communication devices to be performed fairly, once the data transmission is finished, data cannot be transmitted again unless a predetermined transmission waiting time is reset, and thus there is a problem that the delay does not converge endlessly due to this reset of the transmission waiting time.

Furthermore, in a case of the wireless LAN system, data is transmitted if data transmission is not performed in the surroundings of the transmission side communication device, but there is a problem that this data cannot be correctly decoded if communication is performed in the surroundings of the reception side communication device.

On the other hand, as a technology proposal to which a recent wireless LAN system is applied, in a case where data of a specific application is transmitted by occupying and using a specific channel, it is required to adjust the use of the specific channel in advance between the communication devices on the transmission side and the reception side, and it is necessary to notify other communication devices in the surroundings of the communication devices of this fact.

Furthermore, in recent years, use of abundant frequency resources has increased due to explosive demand for data communication, and securing itself of a dedicated channel for specific communication has become difficult.

The conventional access control method is configured to transmit data in a case where the transmission side communication device determines that a transmission path is available, and thus there is a case where communication is performed in the surroundings of the reception side communication device and the transmitted data cannot be correctly received. In the conventional RTS/CTS control, transmission from another communication device existing in a range not affecting reception of the reception side communication device is also suppressed, and it has been difficult to efficiently use the transmission path.

Furthermore, since the conventional return of the acknowledgment (ACK) is performed immediately after the end of data reception from the reception side communication device, in a case where another communication device is performing data reception, there is a possibility that data cannot be correctly received due to the return of the ACK.

Therefore, in the present technology, in order to reliably perform data communication with a shorter delay time in an environment where a transmission path is shared with another wireless communication network, a configuration is proposed in which the reception side communication device transmits a communicable signal at a predetermined cycle, and in a case where the transmission side communication device is also capable of performing transmission, data of a predetermined capacity is received at a predetermined cycle, so that the above-described problem can be solved.

Hereinafter, embodiments of the present technology will be described with reference to the drawings.

(Configuration of Network)

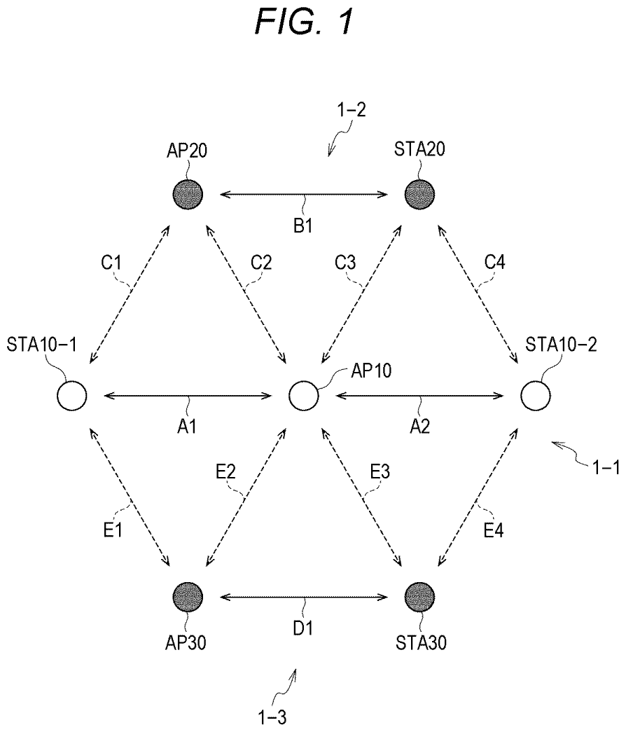

FIG. 1 illustrates an example of a configuration of a wireless communication network by a wireless communication system to which the present technology is applied. Here, a configuration of a wireless LAN system is illustrated as an example of the wireless communication system.

In FIG. 1, communication devices 10 constituting a wireless LAN system 1-1 are indicated by white circles in the drawing, and solid arrows A1 and A2 in the drawing indicate that the respective communication devices 10 are communicable in a state where a communication terminal STA10-1 and a communication terminal STA10-2 are connected to an access point AP10.

In the vicinity of the wireless LAN system 1-1, an access point AP20 and a communication terminal STA20 indicated by shaded circles in the drawing constitute another wireless LAN system 1-2, and a solid arrow B1 in the drawing indicates that the respective communication devices 20 are communicable.

Furthermore, in the vicinity of the wireless LAN system 1-1, an access point AP30 and a communication terminal STA30 indicated by shaded circles in the drawing further constitute another wireless LAN system 1-3, and a solid arrow D1 in the drawing indicates that the respective communication devices 30 are communicable.

The access point AP10 is present at a position where signals from the access point AP20 and the communication terminal STA20 and signals from the access point AP30 and the communication terminal STA30 can be received, which are represented by dashed arrows C2 and C3 and arrows E2 and E3 in the drawing.

The communication terminal STA10-1 is present at a position where signals from the access point AP20 and the access point AP30 can be received, which are represented by a dashed arrow C1 and an arrow E1 in the drawing. Furthermore, the communication terminal STA10-2 is present at a position where signals from the communication terminal STA20 and the communication terminal STA30 can be received, which are represented by a dashed arrow C4 and an arrow E4 in the drawing.

As described above, the access point AP10, the communication terminal STA10-1, and the communication terminal STA10-2 constituting the wireless LAN system 1-1 need to perform fair access between these communication devices due to the existence of the wireless LAN system 1-2 and the wireless LAN system 1-3.

Note that, hereinafter, a communication device that transmits data will be referred to as a transmission side communication device, and a communication device that receives data will be referred to as a reception side communication device. For example, in the wireless LAN system 1-1, data transmitted from a transmission side communication device 10Tx such as the access point AP10 is received by a reception side communication device 10Rx such as the communication terminal STA10-1.

(Transmission of RTA Data)

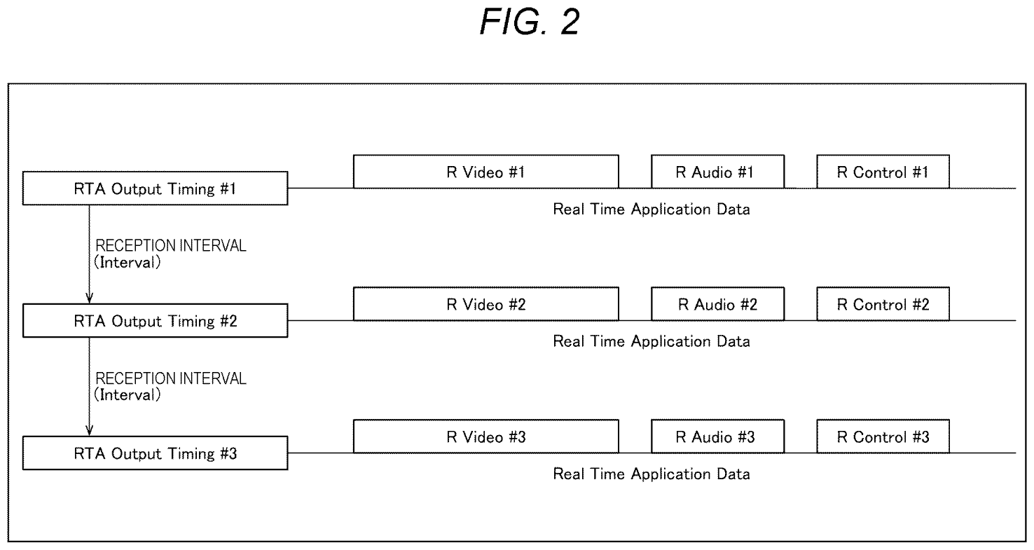

FIG. 2 illustrates a flow of processing of specifying an amount of data of the real time application.

FIG. 2 assumes a case where data of a specific application is received by the transmission side communication device 10Tx, such as a case where arrival of data of the real time application (Real Time Application Data) is not determined.

That is, the data of the real time application (RTA data) is output from the application at any reception interval (Interval) and arrives, and there is a high possibility that the timing has periodicity. For example, in FIG. 2, a first arrival timing (RTA Output Timing #1), a second arrival timing (RTA Output Timing #2), and a third arrival timing (RTA Output Timing #3) of the RTA data have an arbitrary reception interval (Interval).

Furthermore, the data of the real time application may include, for example, data such as video data (R Video), voice data (R Audio), and control information data (R Control), and it is configured that all or a part of these pieces of data reaches in a predetermined periphery.

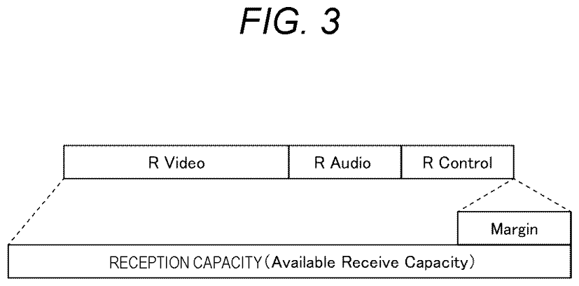

FIG. 3 illustrates a flow of a processing of estimating a reception capacity (Available Receive Capacity).

FIG. 3 illustrates a configuration in which, for example, in a case where there are video data (R Video), voice data (R Audio), and control information data (R Control) as data arriving at each reception interval (Interval), an amount of information obtained by adding a slight margin amount to these pieces of data is calculated as a reception capacity (Capacity). That is, the receivable capacity can be calculated by adding a margin amount according to a transmission rate between the communication devices to the amount of information per unit time of data such as video data.

(Setting of Parameter)

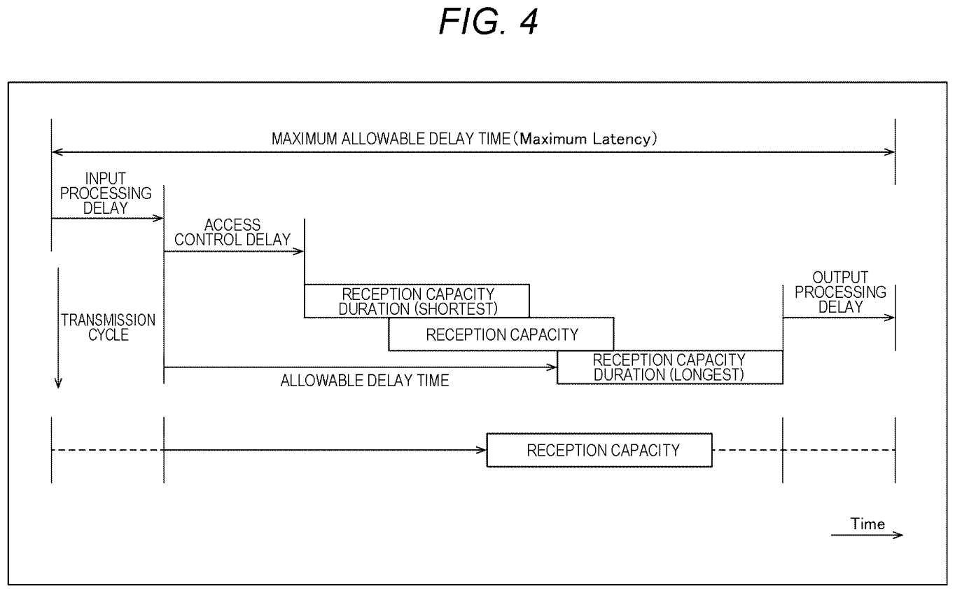

FIG. 4 illustrates an example of setting a transmission parameter used for data transmission.

In FIG. 4, the transmission side communication device 10Tx is configured to add a delay time required for input processing and a delay time required for access control from a maximum allowable delay time (Maximum Latency) by an application indicated by a time axis in a direction from the left side to the right side in the drawing, and perform data transmission within a range of reception capacity duration (Duration).

On the other hand, in the reception side communication device Rx, since a time required for the output processing is necessary, it is desirable to calculate these times and actually transmit data between the shortest state and the longest state of the reception capacity duration. Moreover, here, a series of processing on the transmission side and the reception side is considered as a configuration that arrives every cycle of a constant transmission cycle (Interval).

That is, it is indicated that, in a case where a transmission opportunity is acquired in one transmission cycle (Interval), predetermined data transmission corresponding to a period until the duration of the reception capacity (Capacity) is reached is performed, and the remaining time can be used for other communication.

Note that, for convenience of description, the access control delay illustrated in FIG. 4 is fixedly illustrated, but in practice, it can be seen that the influence is small even if a delay occurs up to a time corresponding to the allowable delay time. Furthermore, in a case where the transmission is started by exceeding the allowable delay time, the next transmission cycle (Interval) arrives, and thus the amount of information obtained by adding the current reception capacity (Capacity) and the next reception capacity (Capacity) may be transmitted in one transmission opportunity.

(Configuration of Communication Device)

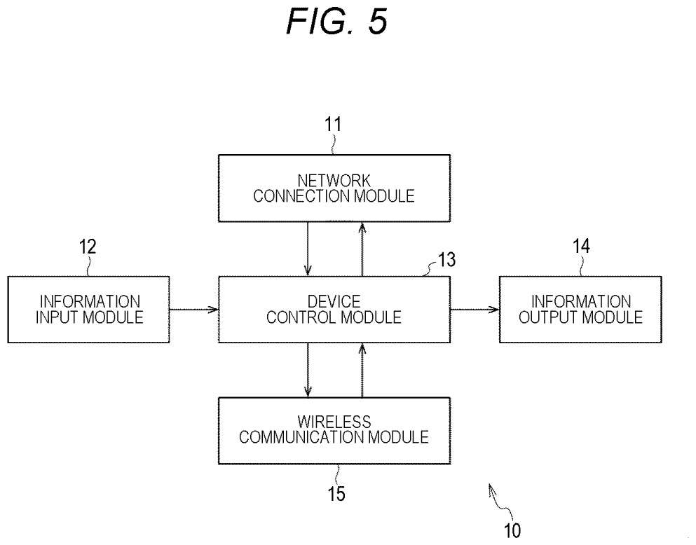

FIG. 5 illustrates an example of a configuration of a communication device to which the present technology is applied.

The communication device 10 illustrated in FIG. 5 is a wireless communication device configured as the access point AP10 or the communication terminal STA10 in the wireless LAN system 1-1 (FIG. 1), that is, the transmission side communication device 10Tx or the reception side communication device 10Rx.

In FIG. 5, the communication device 10 includes a network connection module 11, an information input module 12, a device control module 13, an information output module 14, and a wireless communication module 15.

The network connection module 11 includes, for example, a circuit having a function of connecting an optical fiber network or another communication line to the Internet network via a service provider as the access point AP10 and a peripheral circuit thereof, a microcontroller, a semiconductor memory, and the like.

The network connection module 11 performs various processes related to the Internet connection under the control of the device control module 13. For example, in a case where the communication device 10 operates as the access point AP10, the network connection module 11 has a configuration in which a function such as a communication modem for connecting to the Internet network is mounted.

The information input module 12 includes, for example, an input device such as a push button, a keyboard, or a touch panel. The information input module 12 has a function of inputting instruction information corresponding to an instruction from the user to the device control module 13.

The device control module 13 includes, for example, a microprocessor, a microcontroller, a semiconductor memory, and the like. The device control module 13 controls each unit (module) in order to operate the communication device 10 as the access point AP10 or the communication terminal STA10.

The device control module 13 performs various processes on information supplied from the network connection module 11, the information input module 12, or the wireless communication module 15. Furthermore, the device control module 13 supplies information obtained as a result of its own processing to the network connection module 11, the information output module 14, or the wireless communication module 15.

For example, the device control module 13 supplies transmission data passed from an application or the like of a protocol upper layer to the wireless communication module 15 at the time of data transmission, and passes received data supplied from the wireless communication module 15 to an application or the like of a protocol upper layer at the time of data reception.

The information output module 14 includes, for example, a display element such as a liquid crystal display, an organic EL display, or a light emitting diode (LED) display, or an output device including a speaker that outputs sound or music.

The information output module 14 has a function of displaying necessary information to the user on the basis of the information supplied from the device control module 13. Here, the information processed by the information output module 14 includes, for example, an operation state of the communication device 10, information obtained via the Internet network, and the like.

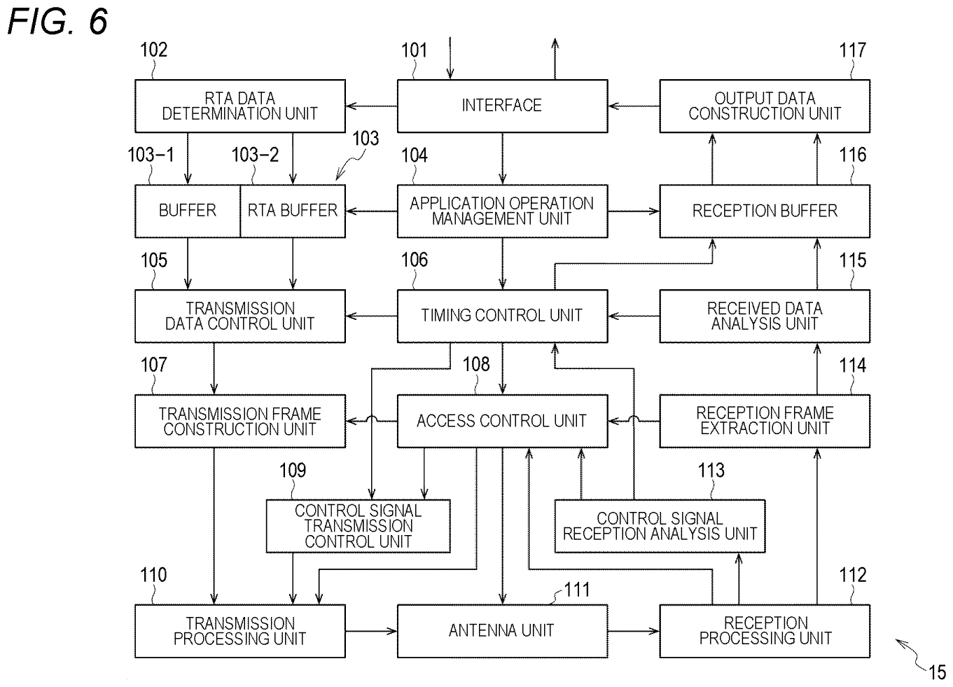

The wireless communication module 15 includes, for example, a wireless chip, a peripheral circuit, a microcontroller, a semiconductor memory, and the like. The wireless communication module 15 performs various processes related to wireless communication under control of the device control module 13. Details of the configuration of the wireless communication module 15 will be described later with reference to FIG. 6.

Note that, here, a wireless communication module on which a wireless communication chip, a peripheral circuit, and the like are mounted will be described as an example, but the present technology is not limited to the wireless communication module, and can be applied to, for example, a wireless communication chip, a wireless communication LSI, and the like. Moreover, in the wireless communication module, whether to include an antenna is optional.

Furthermore, in the communication device 10 of FIG. 5, the device control module 13 and the wireless communication module 15 are necessary components, but whether the network connection module 11, the information input module 12, and the information output module 14 excluding them are included in the components is optional.

That is, each of the communication devices 10 operating as the access point AP10 or the communication terminal STA10 can be configured with only necessary modules, and unnecessary portions can be simplified or not incorporated.

More specifically, for example, the network connection module 11 can be incorporated only in the access point AP10, and the information input module 12 and the information output module 14 can be incorporated only in the communication terminal STA10.

FIG. 6 illustrates a configuration example of the wireless communication module 15 of FIG. 5.

The wireless communication module 15 includes an interface 101 that is connected to other modules and exchanges various types of information and data, an RTA data determination unit 102 that determines an attribute of transmission data from an access category, and a transmission buffer 103 that temporarily stores transmission data for each category.

The transmission buffer 103 includes a buffer 103-1 as a normal transmission buffer. Furthermore, an RTA buffer 103-2 may be added to the transmission buffer 103 as a dedicated buffer space for storing data for real time applications.

This configuration includes an application operation management unit 104 that controls transmission and reception operations for a specific application such as a real time application, which is a characteristic configuration of the present technology, and a transmission data control unit 105 that controls data to be transmitted and manages the order of dequeuing and the like.

Moreover, the wireless communication device includes a timing control unit 106 that controls transmission and reception timings, a transmission frame construction unit 107 that constructs a data frame to be transmitted, an access control unit 108 that performs access control on a wireless transmission path and controls transmission of data and control information and reception of data and control information, a control signal transmission control unit 109 that constructs control information as a reception request signal and controls transmission, and a transmission processing unit 110 that constructs data to be actually transmitted as a signal.

This may include the antenna unit 111 for actually transmitting a signal from the antenna group (not illustrated) and receiving the transmitted signal, but the actual state of the antenna may not exist in the module, and a configuration existing in the communication device 10 or a configuration in which an external antenna is connected to operate may be employed.

On the other hand, the wireless communication module 15 includes, as operation on the reception side, a reception processing unit 112 that receives a predetermined signal received by the antenna, a control signal reception analysis unit 113 that receives control information such as a reception request signal and analyzes the control information, a reception frame extraction unit 114 that extracts a predetermined data frame from the received signal, a received data analysis unit 115 that analyzes data included in the received frame, and a reception buffer 116 that temporarily stores the received data.

Moreover, an output data construction unit 117 that constructs data in an output format in order to deliver the data to a predetermined application is included, and the data is finally delivered to an application or the like of a connected device via the interface 101.

Note that, in the configuration illustrated in FIG. 6, an arrow between each block represents a flow and control of data (signal), and each block operates in cooperation with another block connected by the arrow in order to achieve its own function.

That is, for example, the application operation management unit 104 operates in cooperation with each of the interface 101, the transmission buffer 103, the timing control unit 106, and the reception buffer 116 in order to achieve a function related to control of transmission-reception operation for a specific application as a characteristic function of the present technology.

Furthermore, for example, the access control unit 108 operates in cooperation with each of the timing control unit 106, the transmission frame construction unit 107, the control signal transmission control unit 109, the transmission processing unit 110, the antenna unit 111, the reception processing unit 112, the control signal reception analysis unit 113, and the reception frame extraction unit 114 in order to implement functions related to control of transmission and reception of data as characteristic functions of the present technology.

In the wireless communication module 15 configured as described above, in particular, the following processing is performed by the application operation management unit 104, the timing control unit 106, the access control unit 108, and the like controlling the operation of each unit, for example.

That is, in the wireless communication module 15 of the communication device 10 (the reception side communication device 10Rx), the application operation management unit 104, the timing control unit 106, the access control unit 108, the control signal transmission control unit 109, and the like perform control to construct control information (Rx Control Frame) including information regarding a reception capacity (Capacity) of data to be received at a predetermined transmission cycle (Interval), transmit the constructed control information in a case where a transmission opportunity is acquired by random access control with another communication device (the transmission side communication device 10Tx), and receive data corresponding to the reception capacity based on the control information transmitted from another communication device.

Furthermore, in the wireless communication module of the communication device 10 (the transmission side communication device 10Tx), the application operation management unit 104, the timing control unit 106, the access control unit 108, the control signal reception analysis unit 113, and the like perform control to receive predetermined control information (Rx Control Frame) constructed according to a predetermined transmission cycle (Interval) transmitted from another communication device (the reception side communication device 10Rx), construct data to be transmitted on the basis of information regarding a reception capacity (Capacity) of data included in the received control information, and transmit the constructed data in a case where a transmission opportunity is acquired by random access control with another communication device.

(Data Transmission by Communicable Signal)

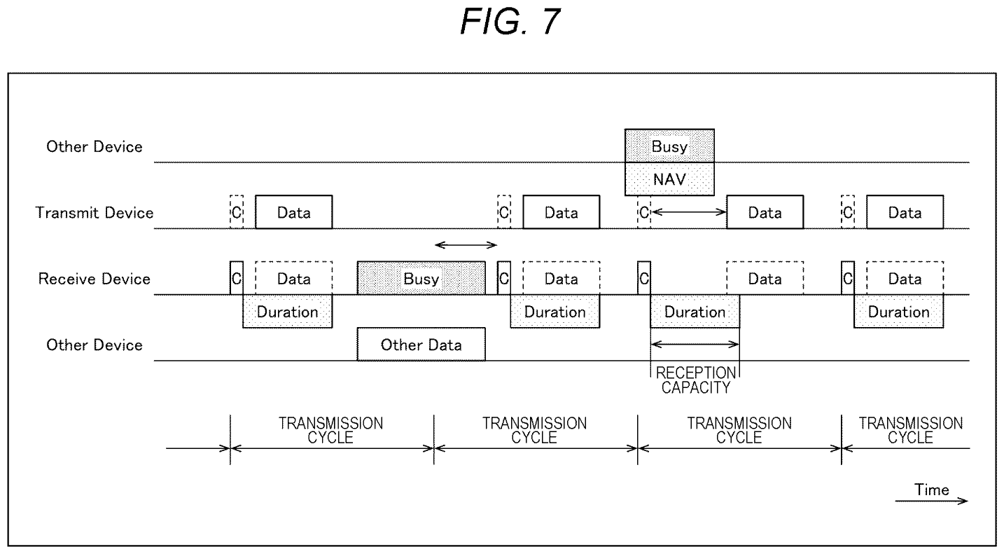

FIG. 7 illustrates an example of data transmission by the communicable signal from the reception side communication device 10Rx.

In FIG. 7, the first stage represents a communication status of another communication device (Other Device), the second stage represents a communication status of the transmission side communication device 10Tx (Transmit Device), the third stage represents a communication status of the reception side communication device 10Rx (Receive Device), and the fourth stage represents a communication status of another communication device (Other Device), illustrating a state in which time elapses from the left side to the right side in the drawing.

FIG. 7 illustrates a state in which a communicable signal C (solid-line quadrangle with “C” in the drawing) is transmitted in a case where a transmission opportunity is acquired at the predetermined transmission cycle (Interval) from the reception side communication device 10Rx to the transmission side communication device 10Tx and the access becomes possible, and data waiting corresponding to information regarding the duration (quadrangle with “Duration” in the drawing) is performed.

Here, the transmission side communication device 10Tx receives the communicable signal C (dashed-line quadrangle with “C” in the drawing) and transmits data of the reception capacity (Capacity) corresponding to the duration designated therein (solid-line quadrangle with “Data” in the drawing).

Accordingly, the reception side communication device 10Rx is configured to receive the data transmitted from the transmission side communication device 10Tx (dashed-line quadrangle with “Data” in the drawing).

Thereafter, in the reception side communication device 10Rx, the communicable signal C is not transmitted and the data communication of the real time application is not performed until the predetermined transmission cycle (Interval) arrives, and thus the remaining time can be used for data transmission of another communication device (quadrangle with “Other Data” in the drawing).

Moreover, in a case where the predetermined transmission cycle (Interval) has arrived, when the transmission path is in a use state with data of another communication device (quadrangle with “Busy” in the drawing), the reception side communication device 10Rx transmits the communicable signal C (solid-line quadrangle with “C” in the drawing) after a predetermined waiting time elapses after waiting for the use state to end.

Here, the transmission side communication device 10Tx is configured not to transmit data unless receiving the communicable signal C even when the predetermined transmission cycle (Interval) arrives, and to transmit predetermined data after the reception side communication device 10Rx becomes capable of receiving data and receives the communicable signal C. Note that, here, the reception capacity (Capacity) of data that can be received at the predetermined transmission cycle (Interval) is also described as duration information (quadrangle with “Duration” in the drawing).

Moreover, even in a case where the transmission side communication device 10Tx receives the communicable signal C from the reception side communication device 10Rx, when the transmission path is used for reception by another adjacent communication device and a network allocation vector (NAV) is set (quadrangle with “NAV” in the drawing), data transmission is refrained until the expiration time elapses.

Then, after a lapse of a predetermined access control waiting time after the end of the NAV, data is transmitted in a period of the duration information of the communicable signal C (quadrangle with “Duration” in the drawing). That is, the reception side communication device 10Rx waits for data reception in a period of the duration information, and thus can start data transmission within the time of the period.

Thereafter, in a case where the predetermined transmission cycle (Interval) has arrived, the communicable signal C is transmitted from the reception side communication device 10Rx, and data corresponding to a predetermined reception capacity (Capacity) is transmitted from the transmission side communication device 10Tx. However, the description thereof will be repeated and thus will be omitted.

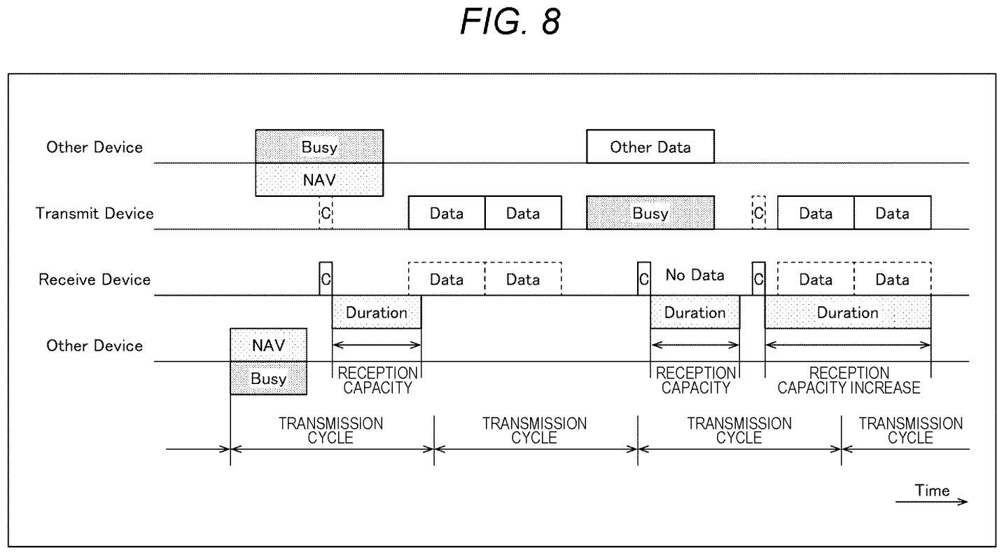

FIG. 8 illustrates another example of data transmission by the communicable signal from the reception side communication device 10Rx.

Similarly to FIG. 7, FIG. 8 illustrates communication statuses of other communication devices in the first and fourth stages, a transmission side communication device (Transmit Device) 10Tx in the second stage, and a reception side communication device (Receive Device) 10Rx in the third stage. In FIG. 8, the description of the same processing as the operations of the transmission side communication device 10Tx and the reception side communication device 10Rx illustrated in FIG. 7 will be omitted as appropriate because it will be repeated.

In FIG. 8, in a case where the predetermined transmission cycle (Interval) has arrived, when the transmission path is used for reception by another communication device (Other Device on the fourth stage) adjacent to the reception side communication device 10Rx and the network allocation vector (NAV) is set (quadrangle with “NAV” in the drawing), a state is illustrated in which the communicable signal C (solid-line quadrangle with “C” in the drawing) is transmitted after a lapse of a predetermined access control waiting time after the end thereof, and data waiting corresponding to the duration information (quadrangle with “Duration” in the drawing) is performed.

However, the transmission side communication device 10Tx is also configured such that, when the transmission path is used for reception by another adjacent communication device (Other Device on the first stage) and the network allocation vector (NAV) is set (quadrangle with “NAV” in the drawing), data transmission is further refrained until the reception ends, and data is transmitted after a predetermined access control waiting time elapses after the termination.

However, since data cannot be transmitted immediately after the communicable signal C is received, when data corresponding to the predetermined reception capacity (Capacity) is transmitted, the next transmission cycle (Interval) is expected to arrive.

In such a case, according to the determination of the transmission side communication device 10Tx, data to be transmitted at the next transmission cycle (Interval) is transmitted together without waiting for reception of the next communicable signal C. Thus, the trouble of transmitting the communicable signal C from the reception side communication device 10Rx is saved, and the time required for the signal exchange is shortened.

Moreover, there is illustrated a state in which the communicable signal C is transmitted from the reception side communication device 10Rx to the transmission side communication device 10Tx at the predetermined transmission cycle (Interval) and data waiting corresponding to the duration information (quadrangle with “Duration” in the drawing) is performed, but data transmission of another communication device (Other Device of the first stage) adjacent to the transmission side communication device 10Tx is performed (quadrangle with “Other Data” in the drawing), and the communicable signal C cannot be received and data transmission has not been performed (quadrangle with “Busy” in the drawing).

In this case, since the reception side communication device 10Rx has not detected the data of the transmission side communication device 10Tx over its duration (quadrangle with “Duration” in the drawing) (“No Data” in the drawing), it is configured to retransmit the communicable signal C.

Here, in a case where it is clear that the duration exceeds the next transmission cycle (Interval), the reception side communication device 10Rx can retransmit the communicable signal C by describing the duration information including the reception capacity (Capacity) of data to be received next time.

Thus, data of two reception capacities can be requested only by transmitting one communicable signal C without transmitting a plurality of communicable signals C. That is, in the transmission side communication device 10Tx, the reception side communication device 10Rx is configured to transmit predetermined data on the basis of the duration information designated as the reception capacity (the reception capacity increased by the reception capacity for a plurality of times). Therefore, the reception side communication device 10Rx and the transmission side communication device 10Tx can perform communication so as to minimize the transmission delay even in an environment where other communication devices exist in the surroundings.

(Data Transmission Including Retransmission Data)

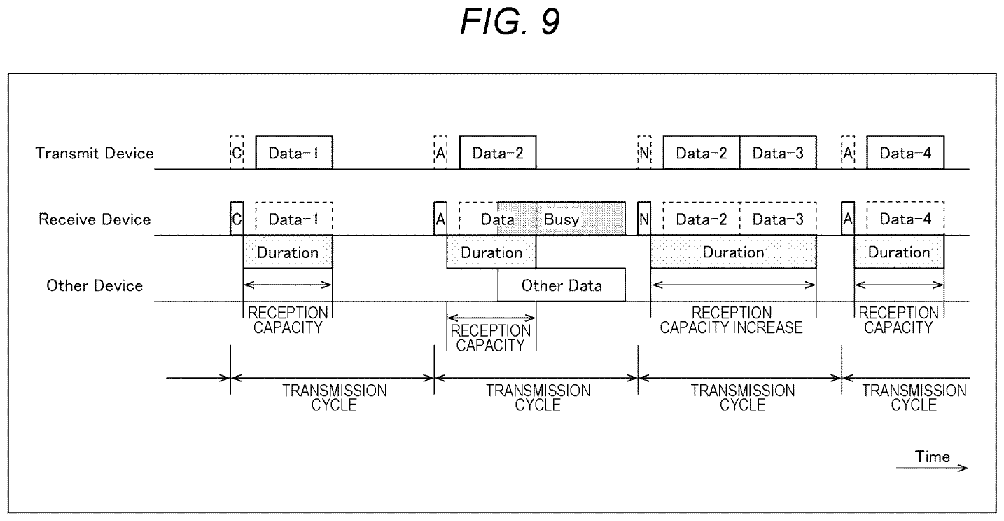

FIG. 9 illustrates an example of data transmission including retransmission data by the communicable signal indicating a reception status.

In FIG. 9, the first stage represents a communication status of the transmission side communication device 10Tx (Transmit Device), the second stage represents a communication status of the reception side communication device 10Rx (Receive Device), and the third stage represents a communication status of another communication device (Other Device), illustrating a state in which time passes from the left side to the right side in the drawing. In FIG. 9, the description of the same processing as the operations of the transmission side communication device 10Tx and the reception side communication device 10Rx illustrated in FIGS. 7 and 8 will be omitted as appropriate because it will be repeated.

Note that, in FIG. 9, although transmission cycles corresponding to approximately four cycles are illustrated, for convenience of description, these cycles are referred to as a first transmission cycle, a second transmission cycle, a third transmission cycle, and a fourth transmission cycle in order from the left, and data to be received in each transmission cycle is referred to as data D1, D2, D3, and D4 in order from the left.

In FIG. 9, it is configured such that information regarding the received data is described in the communicable signal, and notification is performed from the reception side communication device 10Rx to the transmission side communication device 10Tx.

That is, although the parameter indicating the reception situation is not described in the first communicable signal C, information on the data reception situation up to the previous time is added to the second and subsequent communicable signals A and N, and ACK information is described if all the data up to the previous time has been received.

Accordingly, if all the data has been received by a first transmission of the data D1 in the first transmission cycle (quadrangle with “Data-1” in the drawing) in the reception side communication device 10Rx, in a case where the next second transmission cycle (Interval) has arrived, the communicable signal A describing the ACK information is transmitted.

The transmission side communication device 10Tx that has received the communicable signal A has completed reception of all the data up to the previous time, and thus transmits the next data D2 newly reaching the predetermined reception capacity (Capacity) (quadrangle with “Data-2” in the drawing).

However, in a case where data transmission of another communication device adjacent to the reception side communication device 10Rx starts and the next data D2 cannot be correctly received (quadrangle with “Busy” corresponding to “Other Data” in the drawing), when the next third transmission cycle (Interval) has arrived, the communicable signal N describing the NACK information is transmitted.

Note that, in the communicable signal N, a reception capacity (Capacity) including the amount of data to be retransmitted is described as duration information (Duration), and in the third transmission cycle (Interval), the reception side communication device 10Rx is configured to receive both the data D2 to be undelivered and the data D3 received in the third transmission cycle (Interval).

Then, as described in the communicable signal N, the transmission side communication device 10Tx transmits the data D2 (the quadrangle with “Data-2” in the drawing) to be undelivered and the data D3 (quadrangle with “Data-3” in the drawing) received in the third transmission cycle (Interval) together.

Further, if the reception side communication device 10Rx can correctly receive these pieces of data, in a case where the next fourth transmission cycle (Interval) has arrived, the communicable signal A describing the ACK information is transmitted, and the data D4 corresponding to the predetermined reception capacity (Capacity) is transmitted from the transmission side communication device 10Tx (quadrangle with “Data-4” in the drawing).

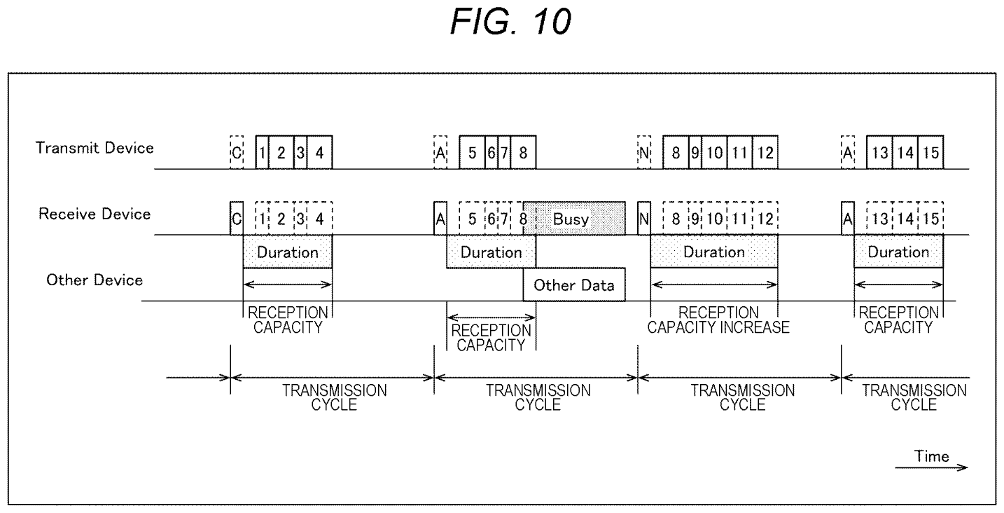

FIG. 10 illustrates another example of the data transmission including the retransmission data by the communicable signal indicating the reception status.

Similarly to FIG. 9, FIG. 10 illustrates communication statuses of the transmission side communication device 10Tx (Transmit Device), the reception side communication device 10Rx (Receive Device), and another communication device (Other Device) in the first to third stages. In FIG. 10, the description of the same processing as the operations of the transmission side communication device 10Tx and the reception side communication device 10Rx illustrated in FIG. 9 will be omitted as appropriate because it will be repeated.

FIG. 10 illustrates a configuration in which retransmission control is performed in units of individual data in a case where a data frame to which a frame aggregation technology is applied is transmitted.

That is, among the data D1 to D4 illustrated in FIG. 9, the data D1 (Data-1) is configured as a data frame obtained by aggregating four pieces of data of d1, d2, d3, and d4 (quadrangles with “1”, “2”, “3”, and “4” in the drawing). Furthermore, data D2 (Data-2) is configured as a data frame in which four pieces of data of d5, d6, d7, and d8 (quadrangles with “5”, “6”, “7”, and “8” in the drawing) are aggregated, and data D3 (Data-3) is configured as a data frame in which four pieces of data of d9, d10, d11, and d12 (quadrangles with “9”, “10”, “11”, and “12” in the drawing) are aggregated.

At this time, the reception side communication device 10Rx has received all of d1 to d4 of the first data D1 in the first transmission cycle, and thus the ACK information is described in the communicable signal A when the next second transmission cycle has arrived. Furthermore, in the second transmission cycle, it is indicated that d5, d6, and d7 could be received at the time of transmission of the data D2, but only d8 could not be correctly received due to data transmission of another communication device adjacent to the reception side communication device 10Rx (quadrangle with “Busy” corresponding to “Other Data” in the drawing).

In this case, when the next third transmission cycle has arrived, NACK information including a fact that d8 of the data D2 could not be received is described, and the reception capacity (Capacity) including retransmission of d8 of the undelivered data D2 is also described in addition to the reception capacity (Capacity) of d9 to d12 of the data D3 to be originally received in the duration information (Duration).

Then, as described in the communicable signal N, the transmission side communication device 10Tx transmits d8 of the data D2 to be undelivered and d9 to d12 of the data D3 received in the third transmission cycle (Interval) together. Moreover, if the reception side communication device 10Rx can correctly receive these pieces of data (d8 to d12), in a case where the next fourth transmission cycle (Interval) has arrived, the communicable signal A describing the ACK information is transmitted.

(Configuration of frame format)

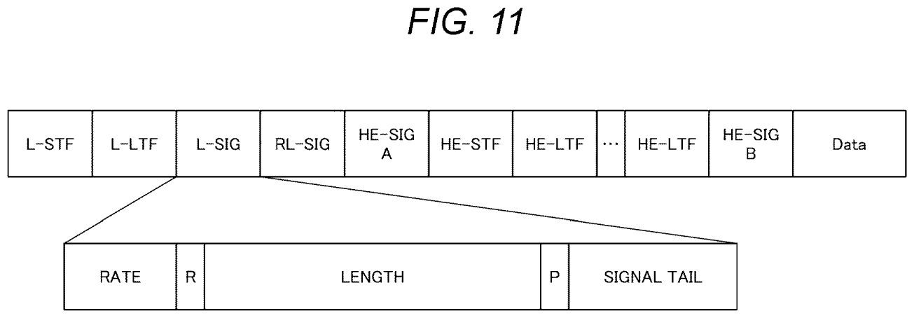

FIG. 11 illustrates an example of a configuration of a frame format.

This frame format is used as a structure common to data and control information used for communication in the wireless LAN system. Note that FIG. 11 illustrates a frame format conforming to the IEEE 802.11ax standard, but in order to maintain backward compatibility, compatibility with the conventional wireless LAN standard is maintained up to the third L-SIG.

In FIG. 11, at the head of the frame, a short training field (L-STF), a long training field (L-LTF), and signaling information (L-SIG) indicating a format and a length of a signal are configured, and are commonly used in the conventional wireless LAN system so far.

The L-SIG includes RATE indicating information for identifying a modulation method and a coding rate of a subsequent data portion, Reserved(R) for future extension, LENGTH indicating an information length of a frame, Parity(P) indicating parity information, and SIGNAL TAIL for performing termination processing of the SIGNAL information portion.

After the L-SIG, the L-SIG that identifies a difference from other standards in the IEEE 802.11ax standard is repeated (RL-SIG), the first signaling information (HE-SIG-A) in the IEEE 802.11ax standard, the short training field (HE-STF) of the IEEE 802.11ax standard, and the spatial multiplexing number used by the long training field (HE-LTF) are configured, and the second signaling information (HE-SIG-B) is configured as a printable and physical layer convergence protocol (PLCP) header information.

After HE-SIG-B, predetermined data can be delivered by actually adding data (Data).

(Configuration of Control Information)

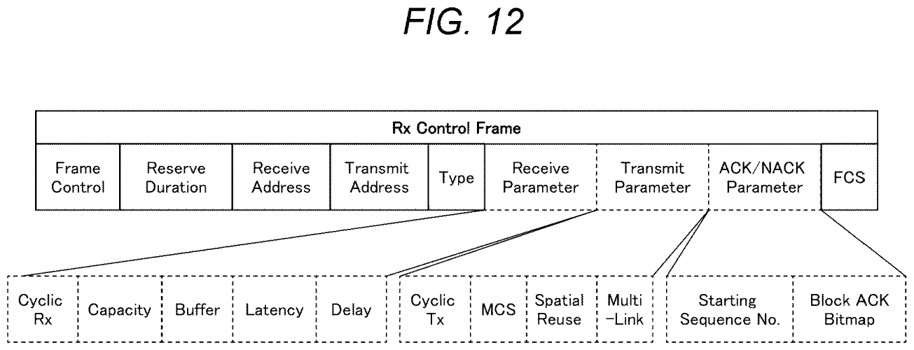

FIG. 12 illustrates a configuration of control information (Rx Control Frame) configured as the communicable signal.

FIG. 12 illustrates a case where a communicable signal is configured as predetermined data in accordance with the frame format illustrated in FIG. 11.

Note that the communicable signal may be configured by adding all of the preamble and the PLCP header information of the frame format illustrated in FIG. 11, but the communicable signal may be configured by adding, as the preamble and the PLCP header information, only a portion of the frame format commonly used in the conventional wireless LAN system.

This communicable signal is configured by adding a frame check sequence (FCS) to Frame Control indicating a type of a frame, Reserve Duration indicating duration after this frame, Receive Address (RA) for identifying a reception side communication device, Transmit Address (TA) for identifying a transmission side communication device, Type for identifying a type of a communicable signal, Receive Parameter indicating a parameter of a periodic reception operation, Transmit Parameter indicating a transmission parameter, and ACK/NACK Parameter indicating a reception status.

The Receive Parameter includes parameters such as Cyclic Rx indicating a periodic reception frequency, Capacity indicating a reception capacity, Buffer indicating a status of the reception buffer, Latency indicating delay time information, and Delay indicating a delay occurrence status, and these parameters are added as necessary.

The Transmit Parameter includes parameters such as Cyclic Tx indicating a periodic transmission frequency, MCS indicating MCS information to be used, Spatial Reuse indicating a parameter of spatial reuse, and Multi-Link indicating a multi-link operation, and these parameters are added as necessary.

The ACK/NACK Parameter includes Starting Sequence No. indicating a starting sequence number and Block ACK Bitmap for reporting a reception status. Note that the ACK/NACK Parameter may be added in response to the request only in a case where the ACK or NACK is identified as the format Type of the communicable signal.

Similarly, Receive Parameter and Transmit Parameter may also be added as necessary, for example, in a case where there is a change, or may be basically a short frame configuration in which address information such as RA and TA and FCS are added to Frame Control and Reserved Duration.

(Configuration of Command)

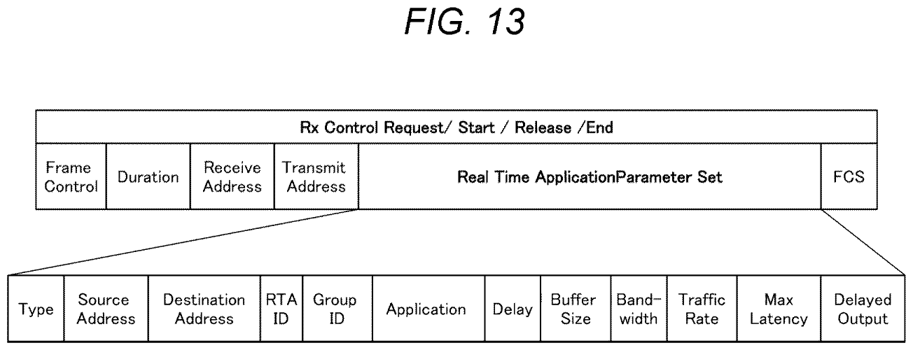

FIG. 13 illustrates an example of a configuration of a command related to setup of control information (Rx Control) regarding communication of the real time application.

These commands are used to give a notification of parameter information as commands of a request command (RxC Request), a start command (RxC Start), a release command (RxC Release), and an end command (RxC End).

Note that since these commands are transmitted by wireless communication, the configuration conforming to the frame format used in the wireless LAN system is illustrated in the example of the configuration illustrated in FIG. 13, but the configuration is not limited thereto.

The frame includes Frame Control indicating the type of the frame, Duration indicating the duration, a Transmit Address identifying the transmission side communication device, and a Receive Address identifying the reception side communication device. Moreover, this frame includes a real time application parameter set (Real Time Application Parameter Set) necessary for implementing control to which the present technology is applied, and is configured by adding a frame check sequence (FCS) to the end.

The real time application parameter set includes information such as Type indicating a command format, Source Address indicating a source address of a transmission source, Destination Address indicating a destination address of a sending destination, RTA ID indicating an identifier of RTA, Group ID indicating a group, Application indicating a type of application, Delay indicating an allowable delay time, Buffer Size indicating a buffer size, Band-Width indicating information of a band-width to be used, Traffic Rate indicating a transmission rate assumed for traffic, Max Latency indicating a maximum delay time, and Delayed Output indicating a data output at the time of occurrence of a delay.

Note that these pieces of information are configured such that necessary portions are described in each command and transmitted from the transmission side, and the information is used on the reception side.

(Configuration of Frame Aggregation)

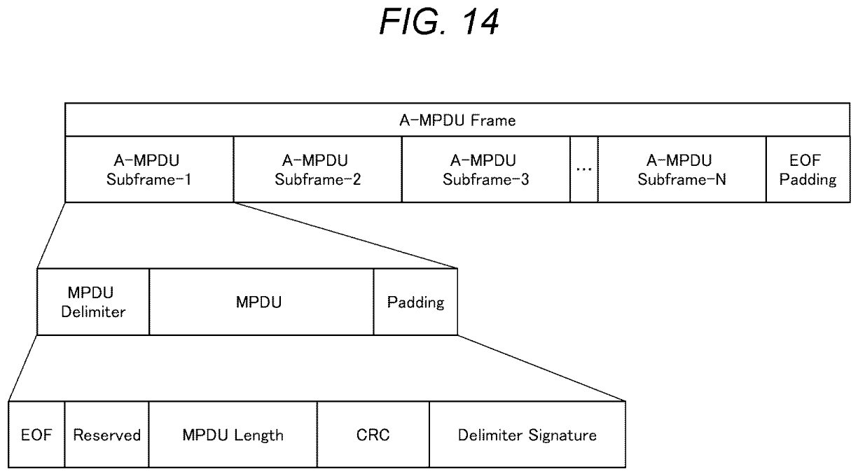

FIG. 14 illustrates an example of a configuration of frame aggregation configured by aggregating a plurality of pieces of data.

In FIG. 14, as data to be actually transmitted, data in units of MAC layer protocol data units (MAC protocol data units (MPDUs)) each capable of detecting errors is configured as a subframe (A-MPDU Subframe), and data including a plurality of subframes is collectively configured as one data frame (A-MPDU Frame).

That is, a plurality of A-MPDU subframes is collected and configured as one A-MPDU frame, and EOF padding added to divide the amount of information of the frame into a predetermined size is added.

In this A-MPDU subframe, an MPDU Delimiter that identifies a boundary of the MPDU and an MPDU in which actual data is stored are configured, and padding Padding added for partitioning the amount of information of the data into a predetermined size is added thereto.

The MPDU Delimiter includes an EOF indicating that the above-described EOF padding is performed, Reserved for future extension, an MPDU Length indicating an information length of the MPDU, a CRC (Cyclic Redundancy Check) for detecting an error of the delimiter, and a Delimiter Signature for identifying the delimiter.

Note that, in the data transmission to which the present invention is applied, a plurality of pieces of data (MPDU) is transmitted as one piece of data according to a predetermined access control procedure. That is, it is configured such that an arbitrary number of data (MPDU) can be transmitted by one access control, and that the parameter (Length) indicating the information length is calculated as the parameter (Duration) of the duration information.

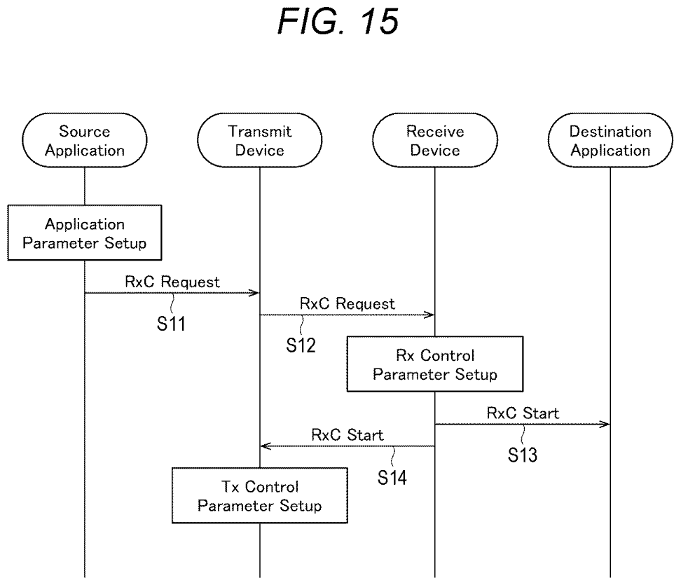

(Flow of RTA parameter exchange) FIG. 15 illustrates an example of a sequence of parameter exchange for the real time application.

FIG. 15 illustrates an example in which various parameters necessary for implementing operations to which the present technology is applied are transferred in each of a transmission source application (Source Application), the transmission side communication device 10Tx (Transmit Device), the reception side communication device 10Rx (Receive Device), and a sending destination application (Destination Application).

For example, in a case where a setting for transmitting specific data as data of a real time application (Application Parameter Setup) is made in the transmission source application, a reception control request (RxC Request) is transmitted to the transmission side communication device 10Tx (S11).

Upon receiving the reception control request (RxC Request), the transmission side communication device 10Tx transmits the reception control request (RxC Request) to the reception side communication device 10Rx connected to the sending destination application by adding a parameter that can be set by the transmission side communication device 10Tx (Destination Application) (S12).

The reception side communication device 10Rx receives the reception control request (RxC Request), estimates parameters that can be set by the reception side communication device 10Rx, and transmits a reception control start (RxC Start) to the sending destination application (S13). Furthermore, in the reception side communication device 10Rx, the reception control start (RxC Start) is also transmitted to the transmission side communication device 10Tx (S14).

Accordingly, by receiving the reception control start (RxC Start), the transmission side communication device 10Tx is configured such that the communicable signal is transmitted at the predetermined transmission cycle from the reception side communication device 10Rx, and setting (Tx Control Parameter Setup) is performed to transmit data corresponding to the predetermined reception capacity.

Note that, here, an example of the configuration in which the parameters are transferred from the transmission source application has been described, however, a configuration in which the parameters are transferred from the sending destination application may be employed, and in this case, directions of respective communication exchanges are changed.

(Flow of Termination of Communication of RTA)

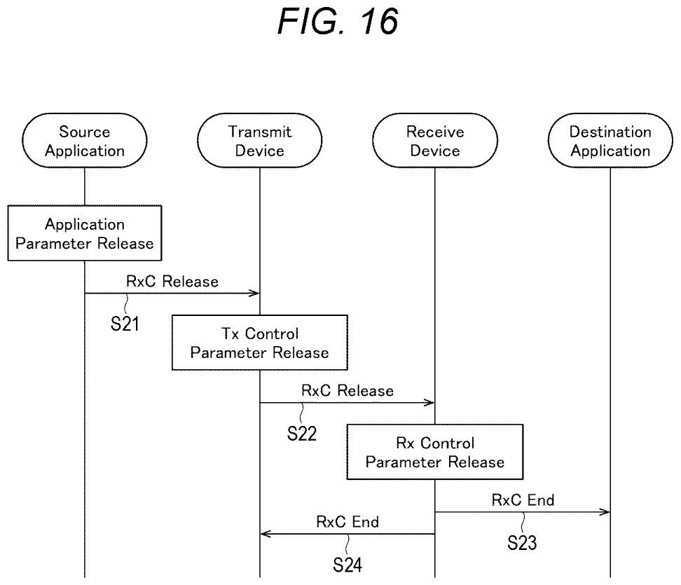

FIG. 16 illustrates an example of a sequence of terminating communication of the real time application.

FIG. 16 illustrates an example in which setting of various parameters necessary for ending the operation to which the present technology is applied is canceled in each of the transmission source application (Source Application), the transmission side communication device 10Tx (Transmit Device), the reception side communication device 10Rx (Receive Device), and the sending destination application (Destination Application).

First, in the transmission source application, in a case where the use of specific data in the real time application ends (Application Parameter Release), a reception control release (RxC Release) is transmitted to the transmission side communication device 10Tx (S21).

The transmission side communication device 10Tx receives the reception control release (RxC Release), releases the set parameter of the transmission side communication device 10Tx (Tx Control Parameter Release), and transmits the reception control release (RxC Release) to the reception side communication device 10Rx connected to the sending destination application (S22).

The reception side communication device 10Rx receives the reception control release (RxC Release), releases the parameter set in the reception side communication device 10Rx (Rx Control Parameter Release), and transmits a reception control end (RxC End) to the sending destination application (Destination Application) (S23). Furthermore, the reception side communication device 10Rx also transmits the reception control end (RxC End) to the transmission side communication device 10Tx (S23).

The transmission side communication device 10Tx is configured to perform setting to stop predetermined data transmission by receiving the reception control end (RxC End).

Note that, here, an example of the configuration in which the parameters are transferred from the transmission source application has been described, however, a configuration in which the parameters are transferred from the sending destination application may be employed, and in this case, directions of respective communication exchanges are changed.

(Flow of Communication)

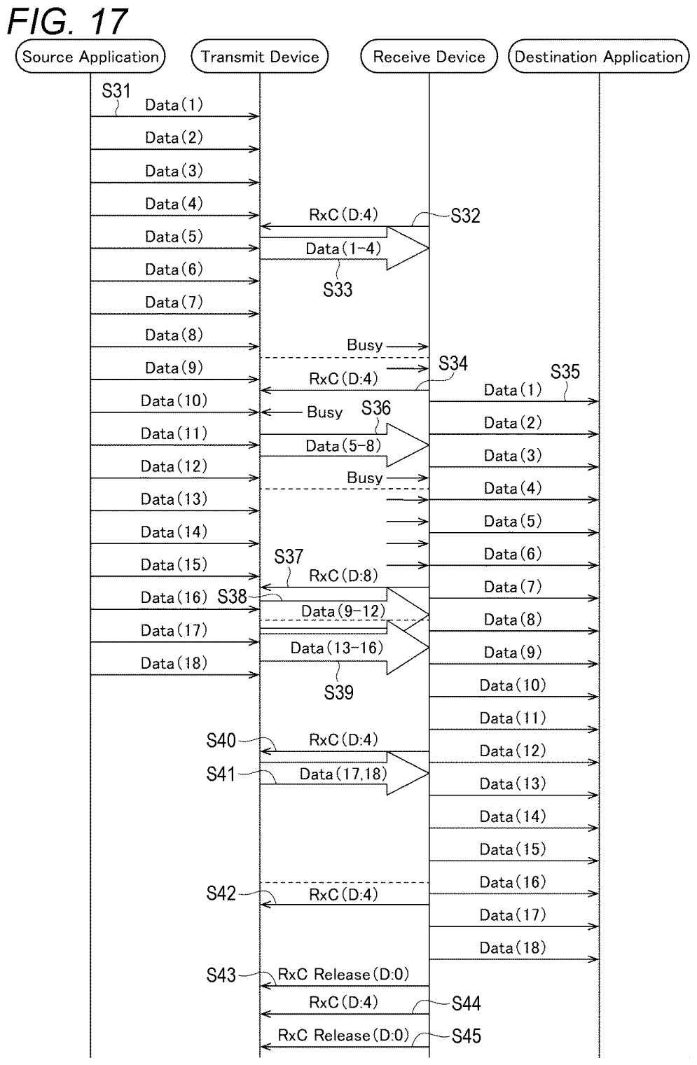

FIG. 17 is a diagram illustrating an example of a communication sequence of the real time application.

FIG. 17 illustrates an example in which a data communication operation to which the present technology is applied is performed in each of the transmission source application (Source Application), the transmission side communication device 10Tx (Transmit Device), the reception side communication device 10R (Receive Device), and the sending destination application (Destination Application).

Note that, when the sequence of FIG. 17 is performed, it is assumed that the setting of the parameters illustrated in FIG. 15 has been performed in advance between the transmission side communication device 10Tx and the reception side communication device 10R.

First, data (Data) is transmitted from the transmission source application to the transmission side communication device 10Tx at a certain frequency. This example illustrates a state in which pieces of data from Data (1) to Data (18) are sequentially transmitted (S31). The transmission side communication device 10Tx is configured to sequentially store data from these specific applications in the transmission buffer 103.

In a case where the transmission path is available at the predetermined transmission cycle on the basis of the parameter set in advance, the reception side communication device 10Rx transmits the communicable signal (RxC) describing the time (D: 4) of the duration information (Duration) as the amount of data corresponding to, for example, four pieces of data transmitted at the predetermined transmission cycle (S32).

Here, in a case of receiving the communicable signal (RxC), when the transmission path is also available for the own device, the transmission side communication device 10Tx transmits Data (1) to (4) corresponding to data that can be transmitted over the time (D: 4) described in the duration information (Duration) (S33).

Moreover, when the transmission path becomes unavailable (Busy) at the predetermined transmission cycle (timing indicated by a horizontal dashed line in the drawing), the reception side communication device 10Rx refrains from transmitting the communicable signal (RxC), and after the transmission path becomes available, the reception side communication device 10Rx transmits the communicable signal (RxC) describing the time (D: 4) of the predetermined duration information in a case where the influence of the delay is small on the basis of the predetermined access control (S34).

When the transmission path becomes unavailable (Busy) even though the communicable signal (RxC) is received, the transmission side communication device 10Tx refrains from transmitting data, and after the transmission path becomes available, the transmission side communication device 10Tx transmits Data (5) to (8) corresponding to data that can be transmitted for a time (D: 4) described in the duration information (Duration) on the basis of the predetermined access control (S36).

Furthermore, when the transmission path becomes unavailable (Busy) at the predetermined transmission cycle (timing indicated by a horizontal dashed line in the drawing), the reception side communication device 10Rx refrains from transmitting the communicable signal (RxC), and after the transmission path becomes available, the reception side communication device 10Rx transmits the communicable signal (RxC) on the basis of the predetermined access control (S37). However, in a case where the transmission path cannot be used for a long time and a predetermined transmission cycle arrives again, data transmission of a plurality of reception capacities can be obtained as a time (D: 8) obtained by adding the time of the duration information (Duration).

In a case of receiving the communicable signal (RxC), when the transmission path is also available for the own device, the transmission side communication device 10Tx transmits Data (9) to (12) and Data (13) to (16) corresponding to data that can be transmitted over the time (D: 8) described in the duration information (Duration) (S38 and S39).

Moreover, when the transmission path becomes available at the predetermined transmission cycle, the reception side communication device 10Rx transmits the communicable signal (RxC) described as being returned to the time (D: 4) of the predetermined duration information (Duration) on the basis of the predetermined access control (S40).

In a case of receiving the communicable signal (RxC), when the transmission path is also available for the own device, the transmission side communication device 10Tx is configured to transmit Data (17) and (18) as all data when only data less than the time (D: 4) described in the duration information (Duration) is stored (S41).

Note that the reception side communication device 10Rx is configured to deliver data to the sending destination application at a predetermined cycle in consideration of a certain delay time, and is configured to sequentially output Data (1) to (18) as predetermined data at a predetermined timing in consideration of the occurrence time of the delay by the access control described above (S35).

Furthermore, when the transmission path is available at the predetermined transmission cycle, the reception side communication device 10Rx transmits the communicable signal (RxC) describing the time (D: 4) of the duration information (Duration) on the basis of the predetermined access control, but in a case where data does not arrive from the transmission side communication device 10Tx for a predetermined time, the communicable signal (RxC) may be retransmitted (S42 and S44).

Alternatively, in a case where there is no response of data from the transmission side communication device 10Tx even though the communicable signal (RxC) is transmitted or in a case where all the data has been output, the reception side communication device 10Rx may be configured to transmit the signal (RxC Release) for canceling the use as a (D: 0) signal without the duration information (Duration), and stop the use of the transmission path for the communication of another communication device existing in the vicinity (S43 and S45). Furthermore, the communicable signal (RxC) may be transmitted a plurality of times in consideration of the possibility that it cannot be received by the transmission side communication device 10Tx.

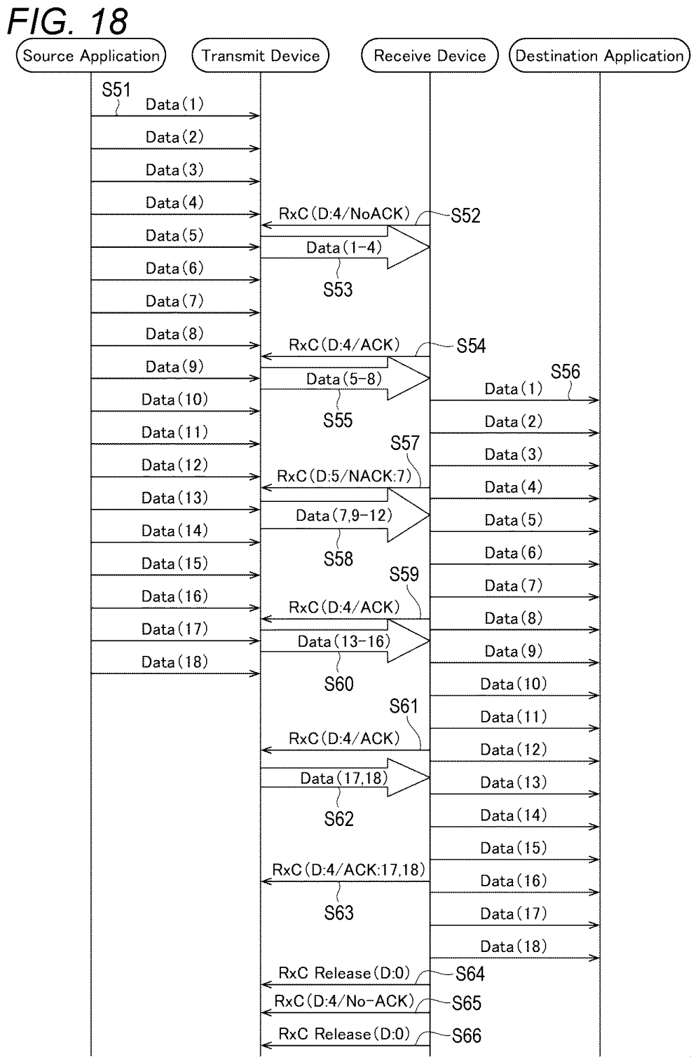

FIG. 18 is a diagram illustrating another example of the communication sequence of the real time application.

FIG. 18 illustrates an example in which a data communication operation to which the present technology is applied is performed in each of the transmission source application (Source Application), the transmission side communication device 10Tx (Transmit Device), the reception side communication device 10Rx (Receive Device), and the sending destination application (Destination Application).

FIG. 18 illustrates a flow of a method of transmitting the communicable signal (RxC) illustrated in FIG. 17 together with the ACK/NACK information indicating the reception status. Note that, when the sequence of FIG. 18 is performed, it is assumed that the setting of the parameters illustrated in FIG. 15 has been performed in advance between the transmission side communication device 10Tx and the reception side communication device 10Rx.

First, data (Data) is transmitted from the transmission source application to the transmission side communication device 10Tx at a certain frequency. This example illustrates a state in which pieces of data from Data (1) to Data (18) are sequentially transmitted (S51). The transmission side communication device 10Tx is configured to sequentially store data from these specific applications in the transmission buffer 103.

In a case where the transmission path is available at the predetermined transmission cycle on the basis of the parameter set in advance, the reception side communication device 10Rx transmits the communicable signal (RxC) describing the time (D: 4) of the duration information (Duration) (S52). Note that, in the first transmission of the communicable signal (RxC), there is no previously transmitted data, and thus the ACK/NACK information may not be described.

Here, in a case of receiving the communicable signal (RxC), when the transmission path is also available for the own device, the transmission side communication device 10Tx transmits Data (1) to (4) corresponding to data that can be transmitted over the time (D: 4) described in the duration information (Duration) (S53).

Moreover, the reception side communication device 10Rx collects the reception statuses of these pieces of Data (1) to (4) as ACK/NACK information, and transmits the communicable signal (RxC) describing the ACK/NACK information when the transmission path is available in a case where the timing has arrived at the predetermined transmission cycle (S54). That is, when all pieces of Data (1) to (4) have been received, the communicable signal (RxC) to which the ACK information is added is transmitted.

In a case of receiving the communicable signal (RxC) to which the ACK information is added, the transmission side communication device 10Tx recognizes that Data (1) to (4) transmitted earlier has arrived, and transmits Data (5) to (8) corresponding to data that can be transmitted this time or later over the time (D: 4) described in the duration information (Duration) (S55).

Moreover, the reception side communication device 10Rx collects the reception status of these pieces of Data (5) to (8) as ACK/NACK information, and transmits the communicable signal (RxC) describing the ACK/NACK information when the transmission path is available in a case where the timing has arrived at the predetermined transmission cycle (S57).

That is, when Data (7) has not been received among Data (5) to (8), the communicable signal (RxC) in which the NACK information is added and the time (D: 5) at which a retransmission portion is added to the duration information (Duration) is described is transmitted.

Here, in a case of receiving the communicable signal (RxC) to which the NACK information is added, the transmission side communication device 10Tx recognizes that Data (7) transmitted earlier is undelivered, and transmits Data (7) which is the undelivered data and Data (9) to (12) corresponding to data that can be transmitted this time or later over the time (D: 5) described in the duration information (Duration) (S58).

Moreover, the reception side communication device 10Rx collects the reception statuses of these pieces of Data (7) and Data (9) to (12) as ACK/NACK information, and transmits the communicable signal (RxC) describing the ACK/NACK information when the transmission path is available in a case where the timing has arrived at the predetermined transmission cycle (S59). That is, when all pieces of Data (7) and Data (9) to (12) have been received, the ACK information is added, and the predetermined communicable signal (RxC) in which the time (D: 4) at which the duration information (Duration) is returned is described is transmitted.

In a case of receiving the communicable signal (RxC) to which the ACK information is added, the transmission side communication device 10Tx recognizes that Data (7), Data (9) to (12) transmitted earlier has arrived, and transmits Data (13) to (16) corresponding to data that can be transmitted this time or later over the time (D: 4) described in the duration information (Duration) (S60).

Moreover, the reception side communication device 10Rx collects the reception statuses of these pieces of Data (13) to (16) as ACK/NACK information, and transmits the communicable signal (RxC) describing the ACK/NACK information when the transmission path is available in a case where the timing has arrived at the predetermined transmission cycle (S61).

In a case of receiving the communicable signal (RxC) to which the ACK information is added, the transmission side communication device 10Tx is configured to recognize that Data (13) to (16) transmitted earlier has arrived, and transmits Data (17) and (18) as data stored in the transmission buffer 103 if only data less than the time (D: 4) described in the duration information (Duration) is stored (S62).

Note that the reception side communication device 10Rx is configured to deliver data to the sending destination application at a predetermined cycle in consideration of a certain delay time, and is configured to sequentially output Data (1) to (18) as predetermined data at a predetermined timing in consideration of the occurrence time of the delay by the access control described above (S56).

Furthermore, when the transmission path is available at the predetermined transmission cycle, the reception side communication device 10Rx transmits the communicable signal (RxC) describing the time (D: 4) of the duration information (Duration) on the basis of predetermined access control, but here, the reception side communication device 10Rx transmits the communicable signal (RxC) describing the ACK/NACK information of Data (17) and (18) (S63). Then, in a case where the data does not arrive from the transmission side communication device 10Tx for a predetermined time, the communicable signal (RxC) in which the ACK/NACK information is not described may be transmitted (S65).

Alternatively, in a case where there is no response of data from the transmission side communication device 10Tx even though the communicable signal (RxC) is transmitted, the reception side communication device 10Rx may be configured to transmit the signal (RxC Release) for canceling the use as a (D: 0) signal without the duration information (Duration), and stop the use of the transmission path for the communication of another communication device existing in the vicinity (S64 and S66).

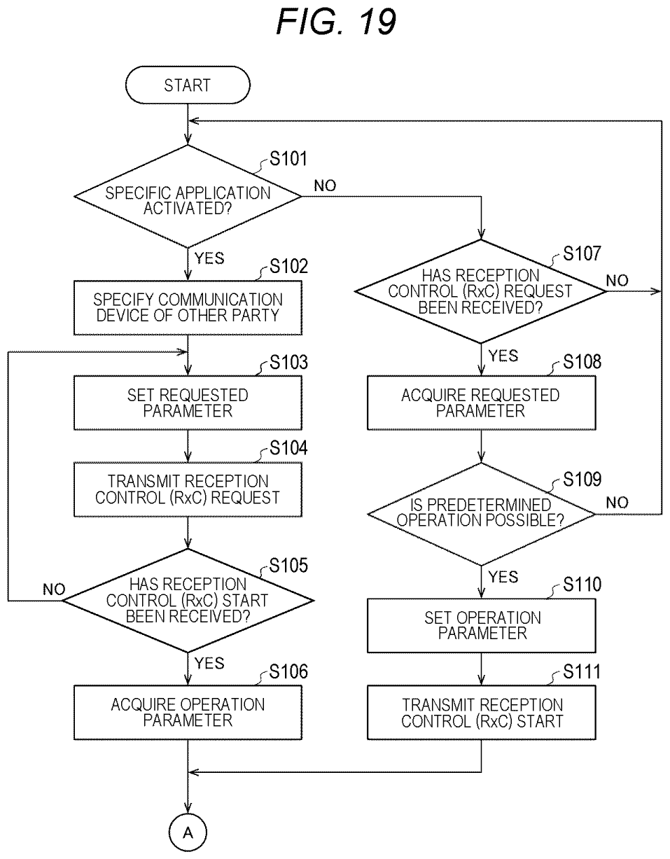

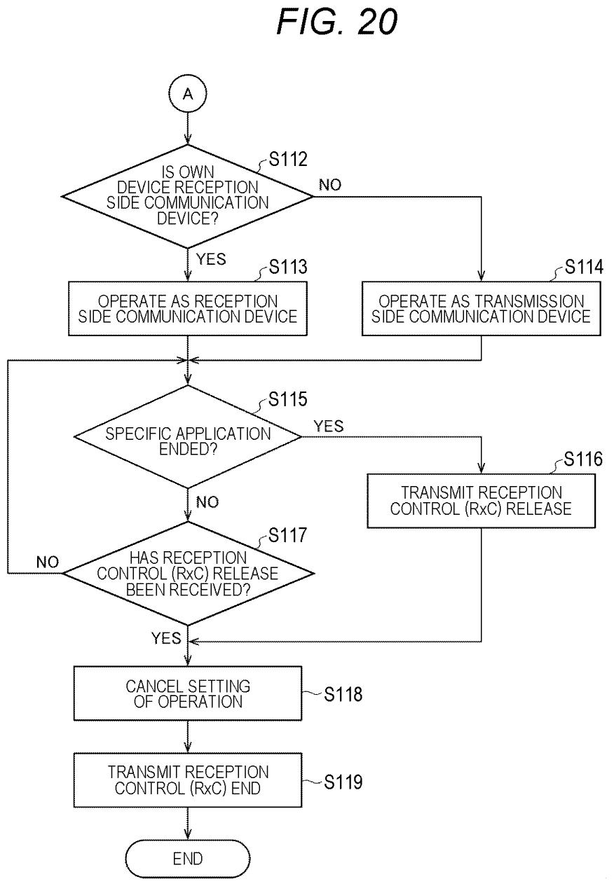

(Communication setup operation) Next, operation setting processing related to communication setup will be described with reference to flowcharts of FIGS. 19 and 20.

In step S101, the application operation management unit 104 determines whether the user has activated a specific application such as a real time application, and in a case where it is determined that the user has activated the specific application (“YES” in S101), the processing proceeds to step S102, and the processing in steps S102 to S106 is executed by the application operation management unit 104 and the like.

Here, processing in steps S102 to S106 is performed on the transmission side communication device 10Tx that transmits data or the reception side communication device 10Rx that receives data on the basis of a notification from a device equipped with a specific application.

That is, when the communication device 10 of the other party is specified (S102) and a parameter to be requested is set (S103), the reception control request (RxC Request) is transmitted to the specified communication device 10 on the other side (S104). Then, in a case of receiving the reception control start (RxC Start) from the communication device 10 of the other party (“YES” in S105), an operation parameter thereof is acquired (S106), and setting of operation is performed.

Note that, in a case where the reception control start (RxC Start) has not been received (“NO” in S105), the processing returns to the processing of step S103, the requested parameter is designated again (S103), and the reception control request (RxC Request) is transmitted again (S104). However, a configuration may be employed in which the processing is skipped, and the operation related to the setup of the communication may not be performed.

On the other hand, in a case where it is determined in the determination processing of step S101 that the specific application is not activated (“NO” in S101), the processing proceeds to step S107, and the processing of steps S107 to S111 is executed by the application operation management unit 104 and the like.

That is, in a case where activation of a specific application is not detected (“NO” in S101), when the reception control request (RxC Request) is received from the communication device 10 of the other party (“YES” in S107), the requested parameter is acquired (S108). Then, in a case where the predetermined operation is possible (“YES” in S109), an operation parameter of the own device is set (S110), and the reception control start (RxC Start) is transmitted to the communication device 10 of the other party (S111).

Note that, in a case where the reception control request (RxC Request) has not been received (“NO” in S107), or in a case where the predetermined operation cannot be set (“NO” in S109), a configuration may be employed in which the processing returns to step S101, and the operation may wait until these operation requests arrive.

When the processing of step S106 or S111 ends, the processing proceeds to step S112 of FIG. 20.

In step S112, it is determined whether the own device is the reception side communication device 10Rx, and in a case where it is determined that the own device is the reception side communication device 10Rx (“YES” in S112), the own device is operated as the reception side communication device 10Rx (S113). On the other hand, in a case where it is determined that the own device is not the reception side communication device 10Rx (“NO” in S112), it is operated as the transmission side communication device 10Tx (S114).

When the processing of step S113 or S114 ends, the processing proceeds to step S115, and the processing of steps S115 to S119 is executed by the application operation management unit 104 and the like.

That is, in a case where there is a notification from the device on which the specific application is mounted to the own device that is the transmission side communication device 10Tx that transmits data or the reception side communication device 10Rx that receives data (“YES” in S115), such as when termination of the specific application such as the real time application by the user is detected, the reception control release (RxC Release) is transmitted to the other party's communication device (S116), and the processing proceeds to step S118.

Furthermore, in a case where termination of the specific application has not been detected (“NO” in S115), when the reception control release (RxC Release) has been received from the other party's communication device (“YES” in S117), the processing proceeds to step S118. Then, the setting of the operation is canceled (S118), and the reception control end (RxC End) is transmitted to the other party's communication device (S119), thereby completing the series of operations.

The flow of the setting processing of the operation related to the communication setup has been described above.

(Operation of Reception Side)

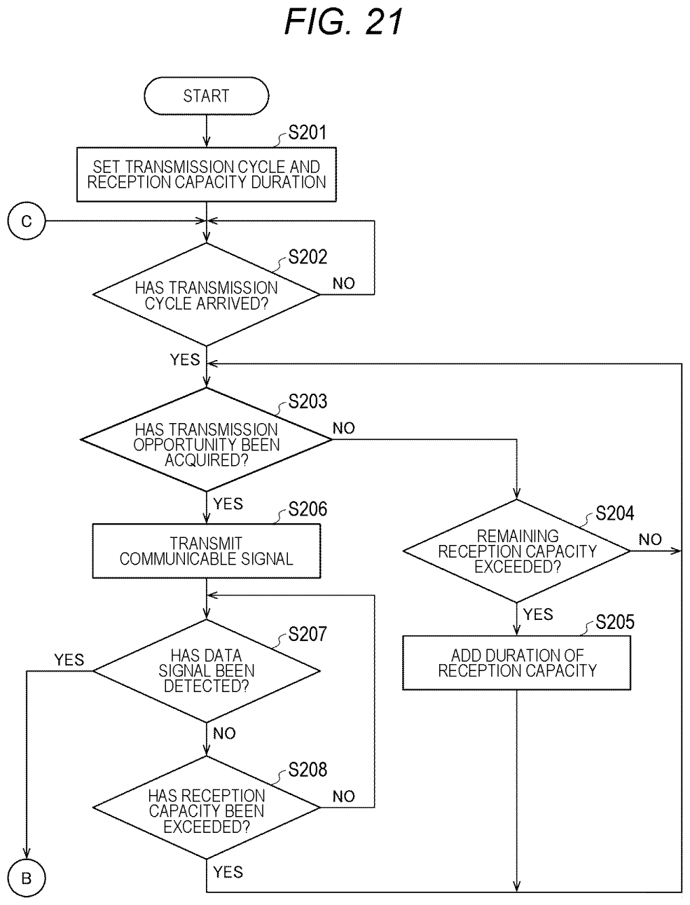

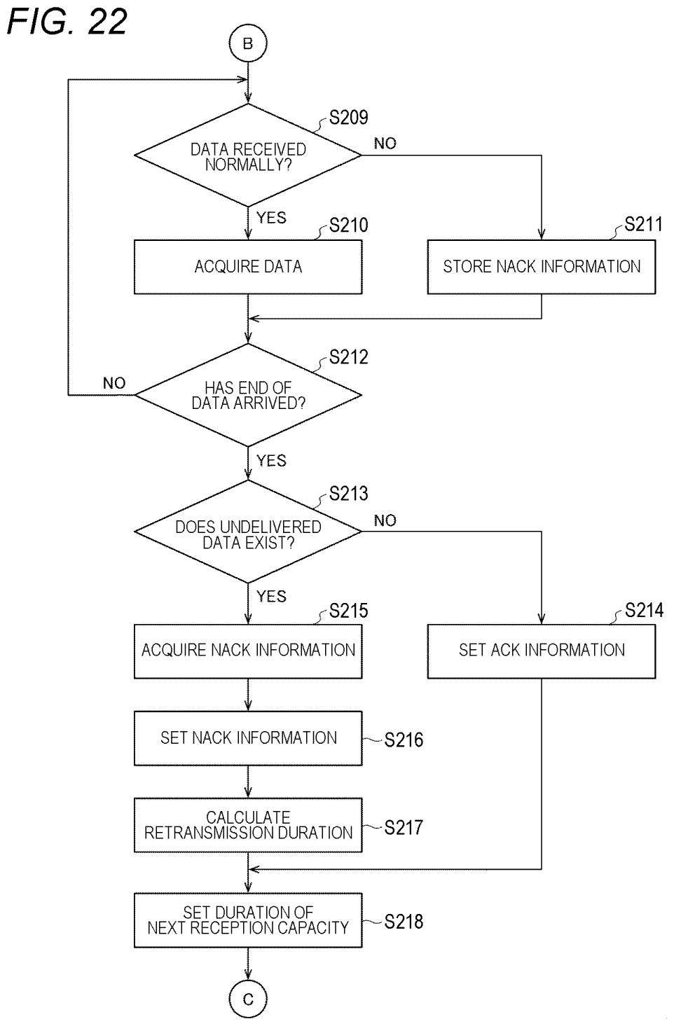

Next, processing of operation of the reception side communication device 10Rx will be described with reference to flowcharts of FIGS. 21 and 22.

In the reception side communication device 10Rx, an arrival cycle of the transmission cycle and duration of the reception capacity are set by the timing control unit 106 (S201), and when a predetermined transmission cycle has arrived (“YES” in S202), the processing proceeds to step S203, and the processing in and after step S203 is executed by the application operation management unit 104, the timing control unit 106, the access control unit 108, the control signal transmission control unit 109, and the like.

That is, in a case where the transmission opportunity (access right) on the transmission path is acquired (“YES” in S203) at the timing when the predetermined transmission cycle has arrived (“YES” in S202), the communicable signal is transmitted (S206). On the other hand, in a case where the transmission opportunity on the transmission path has not been acquired (“NO” in S203), when the remaining time of the transmission cycle exceeds the time described in the duration information as the reception capacity (“YES” in S204), the time corresponding to the next reception capacity is added to the duration information of the reception capacity (S205), and the processing returns to step S203 (“YES” in S203) and is repeated until the transmission opportunity is acquired. Then, when a data signal has not been detected (“NO” in S207) after the communicable signal is transmitted in the processing in step S206, the processing returns to step S207 and the processing of detecting the data signal is performed until the reception capacity is exceeded (“NO” in S208). On the other hand, in a case where the reception capacity is exceeded (“YES” in S208), the processing returns to step S203, and the communicable signal is retransmitted.

On the other hand, in a case where the data signal is detected after the communicable signal is transmitted in the processing of step S206 (“NO” in S207), the processing proceeds to step S209 in FIG. 22. Then, in a case where the data is normally received (“YES” in S209), the data is acquired and stored in the reception buffer 116 (S210). Note that, in a case where the data is not normally received (“NO” in S209), the data is stored as NACK information (S211).

Here, the above-described series of reception processing is repeated until the end of the data to be transmitted arrives (“YES” in S212). For example, in a case where the data to be transmitted is the A-MPDU constituting a frame, when the processing of an intermediate subframe elapses, the processing is returned to step S209, and the reception processing is repeated until the end of the data arrives.

Then, in a case where the tail of the data has arrived (“YES” in S212), when there is no undelivered data (“NO” in S213), ACK information is set (S214), and the duration of the next reception capacity is set (S218).

On the other hand, in a case where the end of the data has arrived (“YES” in S212), when there is undelivered data (“YES” in S213), NACK information specifying the undelivered data is acquired (S215) and set as NACK information in a case where retransmission is necessary (S216), duration information necessary for the retransmission is calculated (S217), and is added to the duration of the next reception capacity to thereby set the duration of the next reception capacity (S218).

After the series of data receiving operations is completed, the processing returns to step S202 in FIG. 21, and the processing is temporarily waited until the next transmission cycle arrives. That is, while the reception side communication device 10Rx is waiting for processing, it is configured to allow using the transmission path for transmission from other surrounding communication devices.

Note that, when the information regarding the reception capacity is calculated in the processing of operation of the reception side communication device 10Rx described above, the information regarding the reception capacity may be calculated according to the processing capability of the device (the reception side communication device 10Rx and the like) such as the buffer capacity and the information processing capability.

The flow of processing of operation of the reception side communication device 10Rx has been described above.

(Operation of Transmission Side)

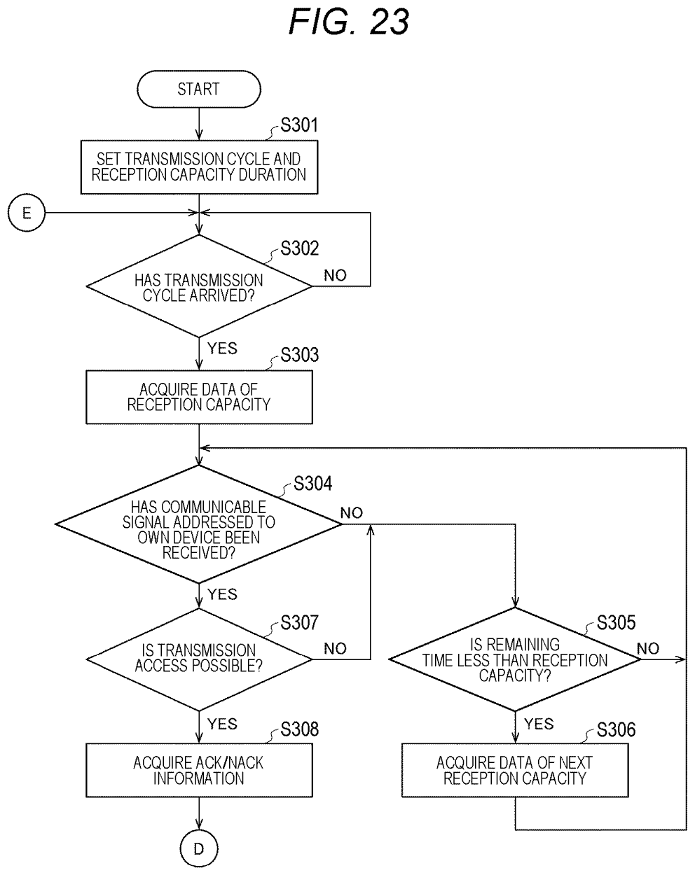

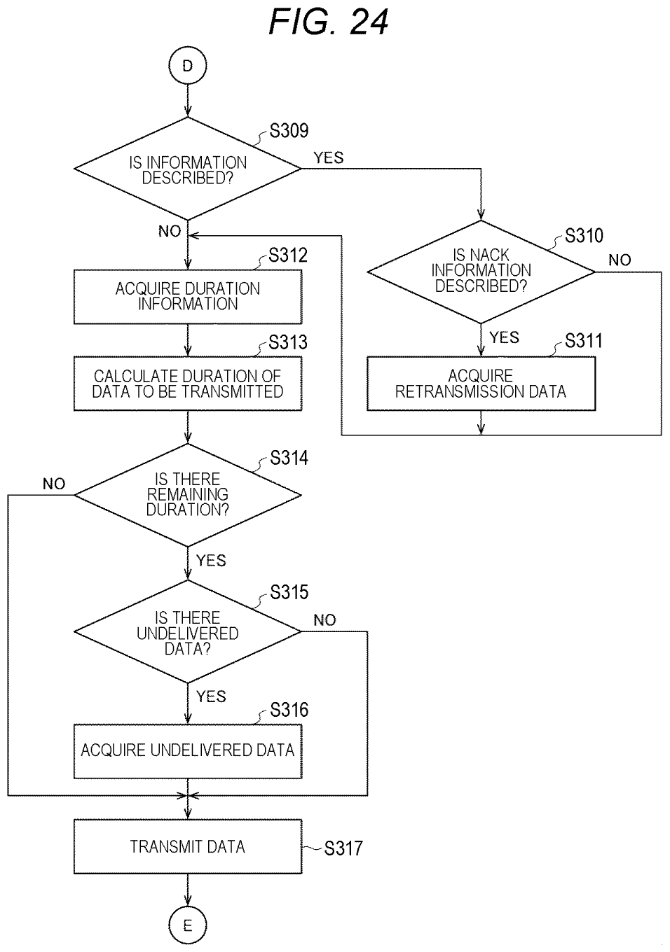

Next, processing of operation of the transmission side communication device 10Tx will be described with reference to flowcharts of FIGS. 23 and 24.

In the transmission side communication device 10Tx, an arrival cycle of the transmission cycle and duration of the reception capacity are set by the timing control unit 106 (S301), and when a predetermined transmission cycle has arrived (“YES” in S302), the processing proceeds to step S303, and the processing in and after step S303 is executed by the application operation management unit 104, the timing control unit 106, the access control unit 108, the control signal reception analysis unit 113, and the like.

That is, data corresponding to the reception capacity is acquired in advance (S303) at the timing when the predetermined transmission cycle has arrived (“YES” in S302). Then, in a case where a communicable signal addressed to the own device has been received (“YES” in S304), the processing proceeds to step S307 and proceeds to a transmission action. On the other hand, in a case where the communicable signal addressed to the own device has not been received (“NO” in S304), when the remaining time of the transmission cycle is likely to exceed the reception capacity (“YES” in S305), data of the reception capacity to be transmitted in the next transmission cycle is acquired in advance (S306). Then, the processing returns to step S304 to wait for the communicable signal.

In a case where the communicable signal addressed to the own device has been received (“YES” in S304), when the own device can perform transmission through the transmission path and can perform transmission access (“YES” in S307), the ACK/NACK information of the communicable signal is acquired (S308), and the processing proceeds to step S309 in FIG. 24. Then, in a case where the information is described (“YES” in S309), when the NACK information is described (“YES” in S310), data to be retransmitted is specified and the retransmission data is acquired (S311). On the other hand, when the ACK information is described (“NO” in S310), the processing in step S311 is skipped.

In a case where the information is not described (“NO” in S309), when the retransmission data is acquired in a case where the NACK information is described (“YES” in S310, S311), or in a case where the ACK information is described (“NO” in S310), the processing proceeds to step S312. Then, the duration information of the communicable signal is acquired (S312), and the duration of the data to be transmitted is calculated (S313).

Here, in a case where the calculated duration is subtracted from the acquired duration information, when there is no remaining duration (“NO” in S314), predetermined data is transmitted (S317). On the other hand, in a case where there is the remaining duration (“YES” in S314), the presence or absence of untransmitted data is confirmed (S315), and in a case where untransmitted data is accumulated (“YES” in S315), the untransmitted data up to the remaining time is acquired (S316), and the predetermined data including the untransmitted data is transmitted (S317). Note that, even in a case where there is a remaining connection time (“YES” in S314), when the untransmitted data is not accumulated (“NO” in S315), the processing in step S316 is skipped, and the predetermined data is transmitted (S317).

After the series of data transmission operations is completed, the processing returns to step S302 in FIG. 23, and the processing temporarily waits until the next transmission cycle arrives. That is, while the transmission side communication device 10Tx is waiting for processing, it is configured to allow using the transmission path for transmission from other surrounding communication devices.

The flow of processing of operation of the transmission side communication device 10Tx has been described above.

<2. Modification Example>

(Another configuration example) As described above, the transmission side communication device 10Tx can be configured as, for example, the access point AP10 (base station), and the reception side communication device 10Rx can be configured as, for example, the communication terminal STA10 (terminal station). However, the transmission side communication device 10Tx or the reception side communication device 10Rx may be configured as a part (for example, a wireless communication module, a wireless chip, or the like) of a device (component) constituting the access point AP10 or the communication terminal STA10.

Furthermore, for example, the reception side communication device 10Rx configured as the communication terminal STA10 can be configured as an electronic device having a wireless communication function, such as a smartphone, a tablet-type terminal, a game device, a mobile phone, a personal computer, a digital camera, a television receiver, a wearable terminal, or a speaker device.

Moreover, the communication terminal STA10 may be a device that supports only data transmission such as a controller that transmits command data according to a user's operation, or a device that supports only data reception such as a display device that receives and displays video data.

As described above, in order to reliably perform data communication with a shorter delay time in an environment where a transmission path is shared with another wireless communication network, the present technology proposes a wireless communication device and a wireless communication control method that transmit the communicable signal at a predetermined cycle from the reception side communication device and transmit data of the specific application such as a real time application in a case where transmission is also possible by the transmission side communication device.

That is, even in a wireless communication method in which a random access control delay occurs such as a wireless LAN system, a communication control method of receiving data of a certain amount of information at a predetermined cycle is proposed in order to minimize the influence of the delay.

Furthermore, a communication control method of real time data has been proposed in which a predetermined transmission cycle and a predetermined reception capacity are determined in advance, and in a case where data reception is performed within the transmission cycle, the communication control method of real time data does not occupy a transmission path more than necessary by not requesting data and allowing use of the transmission path by data transmission of another communication device until the next transmission cycle arrives.

Moreover, a communication control method is proposed in which an allowable delay time is determined, and in a case where data reception cannot be started by the allowable delay time, a request is made including duration of data to be received in the next transmission cycle.

That is, a method is devised in which a communicable signal describing transmission path use time information is transmitted from the communication device that periodically receives data immediately before the predetermined transmission cycle arrives, and data is transmitted according to the communicable signal.

The other communication device that has received the communicable signal refrains from transmitting the transmission path use time information, or sets a transmission parameter within a range not affecting data reception of the communication device that has transmitted the communicable signal, and performs transmission.

In a case where retransmission is requested by describing acknowledgment (ACK) information of data up to the previous time together in the communicable signal, transmission path use time information is set together with a time related to the retransmission.

That is, there is proposed a method of giving a notification that the reception side communication device can perform the reception processing at a predetermined cycle instead of frequently transmitting the data of the real time application, and transmitting the data up to the predetermined reception capacity on the basis of the notification in the transmission side communication device.

The duration information using the transmission path is described in the communicable signal transmitted at a predetermined cycle, and it is possible to identify that data is being received with respect to other communication devices existing in the surroundings. Furthermore, it is possible to describe a specific data reception status up to the previous time in the communicable signal transmitted at the predetermined cycle, and in a case where retransmission is necessary, it is possible to describe and transmit duration information using the transmission path including a time related to the transmission of the retransmission data.

In the present technology, by having the above configuration, data communication can be reliably performed with a shorter delay time, and furthermore, for example, the following effects can be obtained.

That is, by transmitting the communicable signal from the reception side communication device of data, the data transmission can be performed after notifying the transmission side communication device that the data can be reliably received on the transmission path on which the random access is performed. The communicable signal is transmitted in a case where the predetermined transmission cycle has arrived in the reception side communication device of data, and thus the method for reliably receiving the real time application data can be obtained.

The reception capacity can be specified by describing the duration information indicating the use time of the transmission path in the communicable signal, and thus it is possible to give a notification of the amount of data to be transmitted from the transmission side communication device. By describing the duration information of the communicable signal according to the status of the buffer of the reception side communication device, the output frequency of the data, and the like, a method for performing data transmission according to the processing capability of the device can be obtained.

Furthermore, by not transmitting the communicable signal until the predetermined transmission cycle arrives, the transmission path can be shared with other communication devices without occupying the transmission path more than necessary. By constructing the duration information indicating the use time of the transmission path in a format compatible with the conventional method, it is possible to notify other surrounding communication devices of the occupation time of the transmission path, and the other communication devices can set the network allocation vector (NAV) on the basis of the information and suppress transmission that affects reception.

In the transmission side communication device of data, in a case where a communicable signal is received, if the transmission path is available from a previous timing, predetermined data can be immediately transmitted, and thus a method for reliably performing data transmission without setting a transmission waiting time including a random backoff time can be obtained.

That is, transmission of specific data can be performed without delay in cooperation with a transmission method in a conventional wireless LAN system without occupying a transmission path with data of a specific application such as a real time application.

Furthermore, in a case where the communicable signal is received by the transmission side communication device of data and the transmission path is being used, compatibility with the access control method of the related art can be maintained by transmitting the data after a predetermined backoff time elapses from the timing at which the use of the transmission path becomes possible.

Moreover, by the transmission side communication device of data transmitting the data when the transmission path becomes available within the duration of the reception capacity described in the communicable signal, the data transmission can be performed at the timing of waiting in the reception side communication device, and the delay can be minimized.

In the transmission side communication device of data, in a case where the transmission path becomes available, data to be transmitted at the next transmission cycle is added and transmitted in advance in a case where the next transmission cycle is exceeded from the remaining time of the predetermined transmission cycle, and thus a method of avoiding accumulation of delay can be obtained.

By adding previous acknowledgment information to the communicable signal and transmitting the same, it is not necessary to exchange an acknowledgment (ACK) frame after data transmission, and the data reception operation of another communication device is not affected. By setting the reception capacity including data to be retransmitted to the communicable signal including the acknowledgment information and adding the duration information including the reception capacity, a method for more reliably transmitting and receiving retransmission data can be obtained.

(Configuration of Computer)

The processes of respective steps of the above-described flowcharts can be executed by hardware or software. In a case where the series of processes is executed by software, a program constituting the software is installed in a computer of each device.

Here, in the present description, the processing performed by the computer according to the program does not necessarily have to be performed in time series in the order described as the flowchart. That is, the processing performed by the computer according to the program also includes processing that is executed in parallel or individually (for example, parallel processing or object processing).

Furthermore, the program may be processed by one computer (processor) or may be processed in a distributed manner by a plurality of computers. Moreover, the program may be transferred to a distant computer and executed.

Moreover, in the present description, a system means a set of a plurality of components (devices, modules (parts), and the like), and it does not matter whether or not all components are in the same housing.

Note that the embodiments of the present technology are not limited to the above-described embodiments, and various modifications are possible without departing from the gist of the present technology.

Furthermore, each step described in the above-described flowcharts can be executed by one device, or can be executed in a shared manner by a plurality of devices. Moreover, in a case where a plurality of processes is included in one step, the plurality of processes included in the one step can be executed in a shared manner by a plurality of devices in addition to being executed by one device.

Furthermore, the effects described in the present description are merely examples and are not limited, and other effects may be provided.

Note that the present technology can also employ the following configurations.

(1)

A communication device, including

a control unit that performs control to construct control information including information regarding a reception capacity of data to be received at a predetermined transmission cycle,

transmit the constructed control information in a case where a transmission opportunity is acquired by random access control with another communication device, and

receive data corresponding to a reception capacity based on the control information, the data being transmitted from the another communication device.

(2)

The communication device according to (1) above, in which

the control unit

calculates duration of data reception from information regarding a reception capacity in a case where the transmission opportunity is acquired, and

includes information regarding the calculated duration in the control information.

(3)

The communication device according to (2) above, in which

in a case where a reception end time of data corresponding to the reception capacity exceeds a predetermined transmission cycle, the control unit calculates duration of data reception with a plurality of reception capacities as data to be received.

(4)

The communication device according to (2) or (3) above, in which

the control unit retransmits the control information in a case where data is not received after the control information is transmitted and when the duration is exceeded.

(5)

The communication device according to any one of (1) to (4) above, in which

the control unit recognizes a reception status of the received data.

(6)

The communication device according to (5) above, in which

the control unit includes information regarding normal reception of data in the control information.

(7)

The communication device according to (5) above, in which

the control unit includes information for specifying data to be retransmitted in the control information.

(8)

The communication device according to (5) above, in which

the control unit includes, in the control information, information regarding duration of data reception according to an amount of data to be retransmitted.

(9)

The communication device according to any one of (1) to (8) above, in which

the control unit calculates information regarding a reception capacity according to a processing capability of a device.

(10)

A communication method including, by a communication device:

constructing control information including information regarding a reception capacity of data to be received at a predetermined transmission cycle;

transmitting the constructed control information in a case where a transmission opportunity is acquired by random access control with another communication device; and

receiving data corresponding to a reception capacity based on the control information, the data being transmitted from the another communication device.

(11)

A communication device, including

a control unit that performs control to

receive predetermined control information constructed according to a predetermined transmission cycle and transmitted from another communication device,

construct data to be transmitted on the basis of information regarding a reception capacity of data included in the received control information, and

transmit the constructed data in a case where a transmission opportunity is acquired by random access control with the another communication device.

(12)

The communication device according to (11) above, in which

the control unit transmits data corresponding to a predetermined reception capacity on the basis of information regarding duration of data reception included in the control information.

(13)

The communication device according to (12) above, in which

the control unit continuously transmits data up to a next reception capacity in a case where data transmission of the reception capacity is exceeded within a predetermined transmission cycle at a timing at which the transmission opportunity is acquired.

(14)

The communication device according to any one of (11) to (13) above, in which

when the transmission opportunity is not acquired exceeding information regarding duration of data reception included in the control information after the control information is received, the control unit stops performing data transmission.

(15)

The communication device according to any one of (11) to (14) above, in which

the control unit constructs data corresponding to a predetermined reception capacity in a case where the received control information includes information regarding normal reception of data.

(16)

The communication device according to any one of (11) to (14) above, in which

in a case where the received control information includes information for specifying data to be retransmitted, the control unit specifies data to be undelivered.

(17)

The communication device according to (16) above, in which

the control unit retransmits specified undelivered data together with data to be transmitted.

(18)

The communication device according to (16) or (17) above, in which

the control unit specifies a predetermined reception capacity to be transmitted and data to be retransmitted on the basis of a value included in information regarding duration of data reception.

(19)

The communication device according to any one of (11) to (18) above, in which

the control unit stops execution of data transmission during a period from transmission of data corresponding to a predetermined reception capacity to a predetermined transmission cycle.

(20)

A communication method including, by a communication device:

receiving predetermined control information constructed according to a predetermined transmission cycle and transmitted from another communication device;

constructing data to be transmitted on the basis of information regarding a reception capacity of data included in the received control information; and

transmitting the constructed data in a case where a transmission opportunity is acquired by random access control with the another communication device.

### REFERENCE SIGNS LIST

1-1 Wireless LAN system
10 Communication device
11 Network connection module
12 Information input module
13 Device control module
14 Information output module
15 Wireless communication module
101 Interface
102 RTA data determination unit
103 Transmission buffer
103-1 Buffer
103-2 RTA buffer
104 Application operation management unit
105 Transmission data control unit
106 Timing control unit
107 Transmission frame construction unit
108 Access control unit
109 Control signal transmission control unit
110 Transmission processing unit
111 Antenna unit
112 Reception processing unit
113 Control signal reception analysis unit
114 Reception frame extraction unit
115 Reception data analysis unit
116 Reception buffer
117 Output data construction unit

1. A communication device, comprising
a control unit that performs control to
construct control information including information regarding a reception capacity of data to be received at a predetermined transmission cycle,
transmit the constructed control information in a case where a transmission opportunity is acquired by random access control with another communication device, and
receive data corresponding to a reception capacity based on the control information, the data being transmitted from the another communication device.

2. The communication device according to claim 1, wherein
the control unit
calculates duration of data reception from information regarding a reception capacity in a case where the transmission opportunity is acquired, and
includes information regarding the calculated duration in the control information.

3. The communication device according to claim 2, wherein
in a case where a reception end time of data corresponding to the reception capacity exceeds a predetermined transmission cycle, the control unit calculates duration of data reception with a plurality of reception capacities as data to be received.

4. The communication device according to claim 2, wherein
the control unit retransmits the control information in a case where data is not received after the control information is transmitted and when the duration is exceeded.

5. The communication device according to claim 1, wherein
the control unit recognizes a reception status of the received data.

6. The communication device according to claim 5, wherein
the control unit includes information regarding normal reception of data in the control information.

7. The communication device according to claim 5, wherein
the control unit includes information for specifying data to be retransmitted in the control information.

8. The communication device according to claim 5, wherein
the control unit includes, in the control information, information regarding duration of data reception according to an amount of data to be retransmitted.

9. The communication device according to claim 1, wherein
the control unit calculates information regarding a reception capacity according to a processing capability of a device.

10. A communication method comprising, by a communication device:
constructing control information including information regarding a reception capacity of data to be received at a predetermined transmission cycle;
transmitting the constructed control information in a case where a transmission opportunity is acquired by random access control with another communication device; and
receiving data corresponding to a reception capacity based on the control information, the data being transmitted from the another communication device.

11. A communication device, comprising
a control unit that performs control to
receive predetermined control information constructed according to a predetermined transmission cycle and transmitted from another communication device,
construct data to be transmitted on a basis of information regarding a reception capacity of data included in the received control information, and
transmit the constructed data in a case where a transmission opportunity is acquired by random access control with the another communication device.

12. The communication device according to claim 11, wherein
the control unit transmits data corresponding to a predetermined reception capacity on a basis of information regarding duration of data reception included in the control information.

13. The communication device according to claim 12, wherein
the control unit continuously transmits data up to a next reception capacity in a case where data transmission of the reception capacity is exceeded within a predetermined transmission cycle at a timing at which the transmission opportunity is acquired.

14. The communication device according to claim 11, wherein
when the transmission opportunity is not acquired exceeding information regarding duration of data reception included in the control information after the control information is received, the control unit stops performing data transmission.

15. The communication device according to claim 11, wherein
the control unit constructs data corresponding to a predetermined reception capacity in a case where the received control information includes information regarding normal reception of data.

16. The communication device according to claim 11, wherein
in a case where the received control information includes information for specifying data to be retransmitted, the control unit specifies undelivered data.

17. The communication device according to claim 16, wherein
the control unit retransmits specified undelivered data together with data to be transmitted.

18. The communication device according to claim 16, wherein
the control unit specifies a predetermined reception capacity to be transmitted and data to be retransmitted on a basis of a value included in information regarding duration of data reception.

19. The communication device according to claim 11, wherein
the control unit stops execution of data transmission during a period from transmission of data corresponding to a predetermined reception capacity to a predetermined transmission cycle.

20. A communication method comprising, by a communication device:
receiving predetermined control information constructed according to a predetermined transmission cycle and transmitted from another communication device;
constructing data to be transmitted on a basis of information regarding a reception capacity of data included in the received control information; and
transmitting the constructed data in a case where a transmission opportunity is acquired by random access control with the another communication device.
